(19) United States
(12) Patent Application Publication
(10) Pub. No.: US 2025/0294372 A1
(43) Pub. Date: Sep. 18, 2025

(54) FULL-DUPLEX COLLISION HANDLING AND BEAM PAIRING

(71) Applicant: QUALCOMM Incorporated, San Diego, CA (US)

(72) Inventors: Qian ZHANG, Basking Ridge, NJ (US); Junyi LI, Greentown, PA (US); Juergen CEZANNE, Ocean Township, NJ (US)

(21) Appl. No.: 18/606,964

(22) Filed: Mar. 15, 2024

(51) Int. Cl. H04W 16/28; H04L 5/14; H04W 72/0453; H04W 72/25; H04W 72/566

(52) U.S. Cl. CPC H04W 16/28; H04L 5/14; H04W 72/0453; H04W 72/25; H04W 72/566

(57) ABSTRACT

Methods, systems, and devices for wireless communications are described. A first wireless device, such as a user equipment (UE), a vehicle-to-everything (V2X) device, or other wireless communications device may manage collisions of control indications that request transmission of urgent data. The first wireless device may also manage beam configurations based on one or more control indications. The first wireless device may receive multiple control indications from multiple wireless devices. Each control indication may be associated with respective parameters that are configured for each wireless device. The first wireless device may transmit one or more feedback messages based on determining the respective parameters associated with the control indications. The first wireless device may also adjust one or more parameters associated with one or more beam configurations based on receiving the control indications.

### FIELD OF TECHNOLOGY

The following relates to wireless communications, including full-duplex collision handling and beam pairing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support full-duplex collision handling and beam pairing. For example, the described techniques enable a first wireless device (e.g., a UE, a V2X device, a full-duplex device) to manage collisions of control indications requesting to transmit urgent data (e.g., data having a priority above a priority threshold) by other wireless devices, as well as to manage beam configurations based on the control indications. The first wireless device may receive a first control indication from a second wireless device and a may receive second control from a third wireless device. The first control indication and the second control indication may be associated with respective parameters that are configured for (e.g., uniquely configured for, specific to) each wireless device. The first wireless device may transmit one or more feedback messages to the second wireless device and the third wireless device based on determining the respective parameters associated with the first control indication and the second control indication. The first wireless device may also adjust one or more parameters associated with full-duplex beam configurations based on receiving a control indication. Such techniques may reduce latency associated with sidelink communications, improve reliability of full-duplex and other communications, and more efficiently utilize communication resources in a wireless communications system.

A method for wireless communications by a first wireless device is described. The method may include receiving, from a second wireless device, a first control indication associated with a first set of control indication parameters specific to the second wireless device, the first control indication including a first request to transmit a first message from the second wireless device to the first wireless device, where the first wireless device is configured for full-duplex communications, receiving, from a third wireless device, a second control indication associated with a second set of control indication parameters specific to the third wireless device, the second control indication including a second request to transmit a second message from the third wireless device to the first wireless device, and transmitting a feedback message to the second wireless device, the third wireless device, or both based on the first control indication and the second control indication, where the feedback message indicates whether the second wireless device, the third wireless device, or both are to transmit to the first wireless device.

A first wireless device for wireless communications is described. The first wireless device may include one or more memories storing processor executable code, and one or more processors coupled with the one or more memories. The one or more processors may individually or collectively be operable to execute the code to cause the first wireless device to receive, from a second wireless device, a first control indication associated with a first set of control indication parameters specific to the second wireless device, the first control indication including a first request to transmit a first message from the second wireless device to the first wireless device, where the first wireless device is configured for full-duplex communications, receive, from a third wireless device, a second control indication associated with a second set of control indication parameters specific to the third wireless device, the second control indication including a second request to transmit a second message from the third wireless device to the first wireless device, and transmit a feedback message to the second wireless device, the third wireless device, or both based on the first control indication and the second control indication, where the feedback message indicates whether the second wireless device, the third wireless device, or both are to transmit to the first wireless device.

Another first wireless device for wireless communications is described. The first wireless device may include means for receiving, from a second wireless device, a first control indication associated with a first set of control indication parameters specific to the second wireless device, the first control indication including a first request to transmit a first message from the second wireless device to the first wireless device, where the first wireless device is configured for full-duplex communications, means for receiving, from a third wireless device, a second control indication associated with a second set of control indication parameters specific to the third wireless device, the second control indication including a second request to transmit a second message from the third wireless device to the first wireless device, and means for transmitting a feedback message to the second wireless device, the third wireless device, or both based on the first control indication and the second control indication, where the feedback message indicates whether the second wireless device, the third wireless device, or both are to transmit to the first wireless device.

A non-transitory computer-readable medium storing code for wireless communications is described. The code may include instructions executable by one or more processors to receive, from a second wireless device, a first control indication associated with a first set of control indication parameters specific to the second wireless device, the first control indication including a first request to transmit a first message from the second wireless device to the first wireless device, where the first wireless device is configured for full-duplex communications, receive, from a third wireless device, a second control indication associated with a second set of control indication parameters specific to the third wireless device, the second control indication including a second request to transmit a second message from the third wireless device to the first wireless device, and transmit a feedback message to the second wireless device, the third wireless device, or both based on the first control indication and the second control indication, where the feedback message indicates whether the second wireless device, the third wireless device, or both are to transmit to the first wireless device.

In some examples of the method, first wireless devices, and non-transitory computer-readable medium described herein, the first set of control indication parameters includes one or more first signal types, one or more first sequence parameters, one or more first reference signal parameters, one or more first waveform parameters, one or more first frequency resources, or any combination thereof and the second set of control indication parameters includes one or more second signal types, one or more second sequence parameters, one or more second reference signal parameters, one or more second waveform parameters, one or more second frequency resources, or any combination thereof.

Some examples of the method, first wireless devices, and non-transitory computer-readable medium described herein may further include operations, features, means, or instructions for differentiating the first control indication from the second control indication based on a difference of at least one parameter between the first set of control indication parameters and the second set of control indication parameters.

In some examples of the method, first wireless devices, and non-transitory computer-readable medium described herein, transmitting the feedback message to the second wireless device may include operations, features, means, or instructions for transmitting the feedback message indicating that the second wireless device may be to transmit the first message based on determining that the first request includes an indication of an urgent message request.

In some examples of the method, first wireless devices, and non-transitory computer-readable medium described herein, the first control indication and the second control indication may be at least partially overlapped in a time domain and the method, apparatuses, and non-transitory computer-readable medium may include further operations, features, means, or instructions for receiving, via the first control indication, a first priority indication associated with the second wireless device, receiving, via the second control indication, a second priority indication associated with the third wireless device, and transmitting the feedback message indicating that the second wireless device may be to transmit the first message based on the first priority indication being associated with a higher priority than the second priority indication.

In some examples of the method, first wireless devices, and non-transitory computer-readable medium described herein, the first control indication may be orthogonal to the second control indication in a frequency domain based on the first set of control indication parameters and the second set of control indication parameters.

In some examples of the method, first wireless devices, and non-transitory computer-readable medium described herein, transmitting the feedback message may include operations, features, means, or instructions for transmitting an acknowledgment (ACK) message to the second wireless device indicating that the second wireless device may be to transmit the first message based on a first priority associated with the second wireless device being higher than a second priority associated with the third wireless device and transmitting a not-acknowledgment (NACK) message to the third wireless device indicating that the third wireless device may be not to transmit the second message.

In some examples of the method, first wireless devices, and non-transitory computer-readable medium described herein, transmitting the feedback message may include operations, features, means, or instructions for transmitting, to the second wireless device, a first indication of first time resources in which the second wireless device may be allowed to transmit the first message and transmitting, to the third wireless device, a second indication of second time resources in which the third wireless device may be to transmit the second message, where the first time resources may be before the second time resources in a time domain based on a first priority associated with the second wireless device being higher than a second priority associated with the third wireless device.

In some examples of the method, first wireless devices, and non-transitory computer-readable medium described herein, transmitting the feedback message may include operations, features, means, or instructions for transmitting an ACK message to the second wireless device indicating that the second wireless device may be to transmit the first message based on a first priority associated with the second wireless device being higher than a second priority associated with the third wireless device and transmitting, to the third wireless device, an indication of a time offset after which the third wireless device may be to transmit the second message.

In some examples of the method, first wireless devices, and non-transitory computer-readable medium described herein, the first wireless device may have scheduled a transmission of a third message from a fourth wireless device to the first wireless device and the method, apparatuses, and non-transitory computer-readable medium may include further operations, features, means, or instructions for transmitting the feedback message to the second wireless device indicating that the second wireless device may be not to transmit the first message based on a first priority associated with the fourth wireless device being higher than a second priority associated with the second wireless device and transmitting a second feedback message to the third wireless device indicating that the third wireless device may be not to transmit the second message based on the first priority associated with the fourth wireless device being higher than a third priority associated with the third wireless device.

In some examples of the method, first wireless devices, and non-transitory computer-readable medium described herein, the first wireless device may have scheduled a transmission of a third message from a fourth wireless device to the first wireless device and the method, apparatuses, and non-transitory computer-readable medium may include further operations, features, means, or instructions for transmitting a cancelation message to the fourth wireless device that cancels the transmission of the third message based on a first priority associated with the fourth wireless device being lower than a second priority associated with the second wireless device or a third priority associated with the third wireless device.

Some examples of the method, first wireless devices, and non-transitory computer-readable medium described herein may further include operations, features, means, or instructions for receiving the first control indication and the second control indication via a sidelink channel and transmitting the feedback message via the sidelink channel.

Some examples of the method, first wireless devices, and non-transitory computer-readable medium described herein may further include operations, features, means, or instructions for transmitting a third message to a fourth wireless device, where the first control indication and the second control indication may be received simultaneously with transmitting the third message.

A method for wireless communications by a first wireless device is described. The method may include monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications, receiving the control indication from the second wireless device based on the monitoring, and communicating with the second wireless device based on determining one or more parameters associated with the first beam configuration, the second beam configuration, or both in accordance with receiving the control indication.

A first wireless device for wireless communications is described. The first wireless device may include one or more memories storing processor executable code, and one or more processors coupled with the one or more memories. The one or more processors may individually or collectively be operable to execute the code to cause the first wireless device to monitor, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications, receive the control indication from the second wireless device based on the monitoring, and communicate with the second wireless device based on determining one or more parameters associated with the first beam configuration, the second beam configuration, or both in accordance with receiving the control indication.

Another first wireless device for wireless communications is described. The first wireless device may include means for monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications, means for receiving the control indication from the second wireless device based on the monitoring, and means for communicating with the second wireless device based on determining one or more parameters associated with the first beam configuration, the second beam configuration, or both in accordance with receiving the control indication.

A non-transitory computer-readable medium storing code for wireless communications is described. The code may include instructions executable by one or more processors to monitor, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications, receive the control indication from the second wireless device based on the monitoring, and communicate with the second wireless device based on determining one or more parameters associated with the first beam configuration, the second beam configuration, or both in accordance with receiving the control indication.

Some examples of the method, first wireless devices, and non-transitory computer-readable medium described herein may further include operations, features, means, or instructions for adjusting a first beam parameter of the one or more parameters associated with the first beam configuration, where a beam width associated with the first beam configuration decreases based on receiving the control indication and transmitting an indication of the first beam parameter to the second wireless device based on adjusting the first beam parameter, where communicating with the second wireless device may be based on transmitting the indication.

Some examples of the method, first wireless devices, and non-transitory computer-readable medium described herein may further include operations, features, means, or instructions for receiving the second message from the second wireless device based on transmitting the indication and adjusting the first beam parameter of the one or more parameters associated with the first beam configuration, where the beam width associated with the first beam configuration increases based on receiving the second message.

Some examples of the method, first wireless devices, and non-transitory computer-readable medium described herein may further include operations, features, means, or instructions for reducing a transmit power parameter of the one or more parameters associated with the first beam configuration, where a value of the transmit power parameter may be based on a self-interference metric associated with the first beam configuration and the second beam configuration.

Some examples of the method, first wireless devices, and non-transitory computer-readable medium described herein may further include operations, features, means, or instructions for transmitting an indication to the second wireless device to increase a transmit power parameter of the one or more parameters associated with the second beam configuration, where a value of the transmit power parameter may be based on a self-interference metric associated with the first beam configuration and the second beam configuration.

A method for wireless communications by a first wireless device is described. The method may include transmitting, to a second wireless device, a first control indication associated with a first set of control indication parameters specific to the first wireless device, the first control indication including a first request to transmit a first message from the first wireless device to the second wireless device and receiving a feedback message from the second wireless device based on the first control indication, where the feedback message indicates whether the second wireless device is to transmit the first message to the second wireless device.

A first wireless device for wireless communications is described. The first wireless device may include one or more memories storing processor executable code, and one or more processors coupled with the one or more memories. The one or more processors may individually or collectively be operable to execute the code to cause the first wireless device to transmit, to a second wireless device, a first control indication associated with a first set of control indication parameters specific to the first wireless device, the first control indication including a first request to transmit a first message from the first wireless device to the second wireless device and receive a feedback message from the second wireless device based on the first control indication, where the feedback message indicates whether the second wireless device is to transmit the first message to the second wireless device.

Another first wireless device for wireless communications is described. The first wireless device may include means for transmitting, to a second wireless device, a first control indication associated with a first set of control indication parameters specific to the first wireless device, the first control indication including a first request to transmit a first message from the first wireless device to the second wireless device and means for receiving a feedback message from the second wireless device based on the first control indication, where the feedback message indicates whether the second wireless device is to transmit the first message to the second wireless device.

A non-transitory computer-readable medium storing code for wireless communications is described. The code may include instructions executable by one or more processors to transmit, to a second wireless device, a first control indication associated with a first set of control indication parameters specific to the first wireless device, the first control indication including a first request to transmit a first message from the first wireless device to the second wireless device and receive a feedback message from the second wireless device based on the first control indication, where the feedback message indicates whether the second wireless device is to transmit the first message to the second wireless device.

In some examples of the method, first wireless devices, and non-transitory computer-readable medium described herein, the first set of control indication parameters includes one or more first signal types, one or more first sequence parameters, one or more first reference signal parameters, one or more first waveform parameters, one or more first frequency resources, or any combination thereof.

In some examples of the method, first wireless devices, and non-transitory computer-readable medium described herein, receiving the feedback message from the second wireless device may include operations, features, means, or instructions for receiving the feedback message indicating that the first wireless device may be to transmit the first message based on the first request including an indication of an urgent message request.

Some examples of the method, first wireless devices, and non-transitory computer-readable medium described herein may further include operations, features, means, or instructions for transmitting, via the first control indication, a first priority indication associated with the first wireless device and receiving the feedback message indicating that the first wireless device may be to transmit the first message based on the first priority indication.

In some examples of the method, first wireless devices, and non-transitory computer-readable medium described herein, the first control indication may be orthogonal to a second control indication from another wireless device in a frequency domain based on the first set of control indication parameters.

In some examples of the method, first wireless devices, and non-transitory computer-readable medium described herein, receiving the feedback message may include operations, features, means, or instructions for receiving an ACK message or a NACK message from the second wireless device indicating whether the first wireless device may be to transmit the first message based on a first priority associated with the first wireless device.

In some examples of the method, first wireless devices, and non-transitory computer-readable medium described herein, receiving the feedback message may include operations, features, means, or instructions for receiving, from the second wireless device, a first indication of first time resources in which the first wireless device may be allowed to transmit the first message, where the first time resources may be based on a first priority associated with the first wireless device.

In some examples of the method, first wireless devices, and non-transitory computer-readable medium described herein, receiving the feedback message may include operations, features, means, or instructions for receiving an indication of a time offset after which the first wireless device may be to transmit the first message.

Some examples of the method, first wireless devices, and non-transitory computer-readable medium described herein may further include operations, features, means, or instructions for transmitting the first control indication via a sidelink channel and receiving the feedback message via the sidelink channel.

In some examples of the method, first wireless devices, and non-transitory computer-readable medium described herein, the first wireless device may be configured for full-duplex communications.

A method for wireless communications by a first wireless device is described. The method may include transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications and communicating with the second wireless device based on one or more parameters associated with the first beam configuration, the second beam configuration, or both in accordance with transmitting the control indication.

A first wireless device for wireless communications is described. The first wireless device may include one or more memories storing processor executable code, and one or more processors coupled with the one or more memories. The one or more processors may individually or collectively be operable to execute the code to cause the first wireless device to transmit, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications and communicate with the second wireless device based on one or more parameters associated with the first beam configuration, the second beam configuration, or both in accordance with transmitting the control indication.

Another first wireless device for wireless communications is described. The first wireless device may include means for transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications and means for communicating with the second wireless device based on one or more parameters associated with the first beam configuration, the second beam configuration, or both in accordance with transmitting the control indication.

A non-transitory computer-readable medium storing code for wireless communications is described. The code may include instructions executable by one or more processors to transmit, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications and communicate with the second wireless device based on one or more parameters associated with the first beam configuration, the second beam configuration, or both in accordance with transmitting the control indication.

Some examples of the method, first wireless devices, and non-transitory computer-readable medium described herein may further include operations, features, means, or instructions for receiving an indication of a first beam parameter from the second wireless device based on transmitting the control indication, where a beam width associated with the first beam configuration decreases based on receiving the indication.

Some examples of the method, first wireless devices, and non-transitory computer-readable medium described herein may further include operations, features, means, or instructions for transmitting the second message to the second wireless device based on receiving the indication, where the beam width associated with the first beam configuration increases based on transmitting the second message.

Some examples of the method, first wireless devices, and non-transitory computer-readable medium described herein may further include operations, features, means, or instructions for receiving an indication from the second wireless device to increase a transmit power parameter of the one or more parameters associated with the second beam configuration, where a value of the transmit power parameter may be based on a self-interference metric associated with the first beam configuration and the second beam configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications systems that supports full-duplex collision handling and beam pairing in accordance with one or more aspects of the present disclosure.

FIG. 2 shows an example of a network architecture that supports full duplex collision handling and beam pairing in accordance with one or more aspects of the present disclosure.

FIGS. 3 and 4 show examples of wireless communications systems that support full-duplex collision handling and beam pairing in accordance with one or more aspects of the present disclosure.

FIGS. 5 and 6 show examples of process flows that support full-duplex collision handling and beam pairing in accordance with one or more aspects of the present disclosure.

FIGS. 7 and 8 show block diagrams of devices that support full-duplex collision handling and beam pairing in accordance with one or more aspects of the present disclosure.

FIG. 9 shows a block diagram of a communications manager that supports full-duplex collision handling and beam pairing in accordance with one or more aspects of the present disclosure.

FIG. 10 shows a diagram of a system including a device that supports full-duplex collision handling and beam pairing in accordance with one or more aspects of the present disclosure.

FIGS. 11 through 17 show flowcharts illustrating methods that support full-duplex collision handling and beam pairing in accordance with one or more aspects of the present disclosure.

### DETAILED DESCRIPTION

In some wireless communications systems, a wireless communication device (e.g., a network entity, a user equipment (UE), a sidelink device, a vehicle-to-everything (V2X) device, a relay, or other device capable of wireless communications) may be configured to support full-duplex communication designs (e.g., single frequency full-duplex (SFFD), sub-band full-duplex (SBFD)). Full-duplex communication may enable the wireless communication device to simultaneously transmit and receive wireless signals. In some cases, a centralized controller (e.g., a network entity, a central-unit (CU)) may manage transmission and reception scheduling in full-duplex scenarios. However, a centralized controller may not be available to coordinate the transmission and reception scheduling in some scenarios (e.g., in cellular V2X deployments). Thus, a first wireless device (e.g., a full-duplex device, a UE, a sidelink device, a V2X device) may manage full-duplex transmission and reception communications between itself and a second wireless device.

In some cases, the second wireless device may have a relatively urgent (e.g., high priority, a priority level that is above a priority threshold, associated with a priority greater than a priority of another message) data message (e.g., an ultra-reliable low latency communications (URLLC) message) to transmit to the first wireless device and may accordingly transmit a control indication message (e.g., via a sidelink channel) that includes a request to transmit the urgent data to the first wireless device. However, the first wireless device may receive multiple control indications from different wireless devices at the same time or within a same time window (e.g., which may result in a collision of multiple urgent messages), and the first wireless device may not be able to distinguish between the multiple control indication messages and prioritize the corresponding urgent messages accordingly. Further, the full-duplex communications of the first wireless device may be associated with self-interference, and the first wireless device may not support mechanisms to mitigate self-interference based on receiving the multiple control indications. Thus, a wireless device may not support techniques to schedule (e.g., prioritize, coordinate) contending transmissions from other wireless devices or techniques to reduce self-interference associated with full-duplex communications.

In accordance with one or more aspects of the present disclosure, a wireless communications system may support techniques that enable a first wireless device to handle (e.g., manage) collisions between multiple control indication messages that are received from other wireless devices. Moreover, aspects described herein may enable management of full-duplex beam pair configurations based on receiving control indication messages. In some examples, each wireless device may be configured (e.g., by a network entity or a CU) with respective control indication parameters (e.g., device-specific parameters) for transmitting a control indication message. The control indication parameters may be associated with a signal type, a sequence configuration, a reference signal configuration, a waveform type, and frequency resources, among other examples. Thus, a wireless device may be able to differentiate (e.g., distinguish, identify a difference between) colliding control indication messages by associating a given control indication message to a specific wireless device based on corresponding control indication parameters. Each wireless device may also be configured to transmit (e.g., via a control indication message) a priority indication, which may be used (e.g., by a receiving device) to prioritize various communications in accordance with various signaling mechanisms. Additionally, or alternatively, one or more techniques described herein may enable beam management techniques (e.g., for self-interference mitigation) based on receiving a control indication message. For instance, a wireless device may monitor for a control indication message using a first beam configuration (e.g., a relatively wide beam) and may control (e.g., adjust, modify, update) the first beam configuration in response to receiving the control indication message.

By applying the techniques described herein, a wireless communication device may be enabled to support enhanced methods that manage various collision scenarios (e.g., sidelink collision of URLLC and other urgent messages) as well as self-interference mitigation. For instance, by supporting device-specific control indication parameters, wireless devices may independently schedule communications (e.g., full-duplex communications) with reduced involvement of the network (e.g., a network entity, a CU), which may reduce latency and improve data rates. Further, by managing beam configurations based on receiving control indication messages, wireless devices may autonomously reduce self-interference associated with full-duplex communications thereby supporting increased communication reliability and improve utilization of communication resources.

Aspects of the disclosure are initially described in the context of wireless communications systems. Aspects of the disclosure are further illustrated by and described with reference to network architectures, process flows, apparatus diagrams, system diagrams, and flowcharts that relate to full-duplex collision handling and beam pairing.

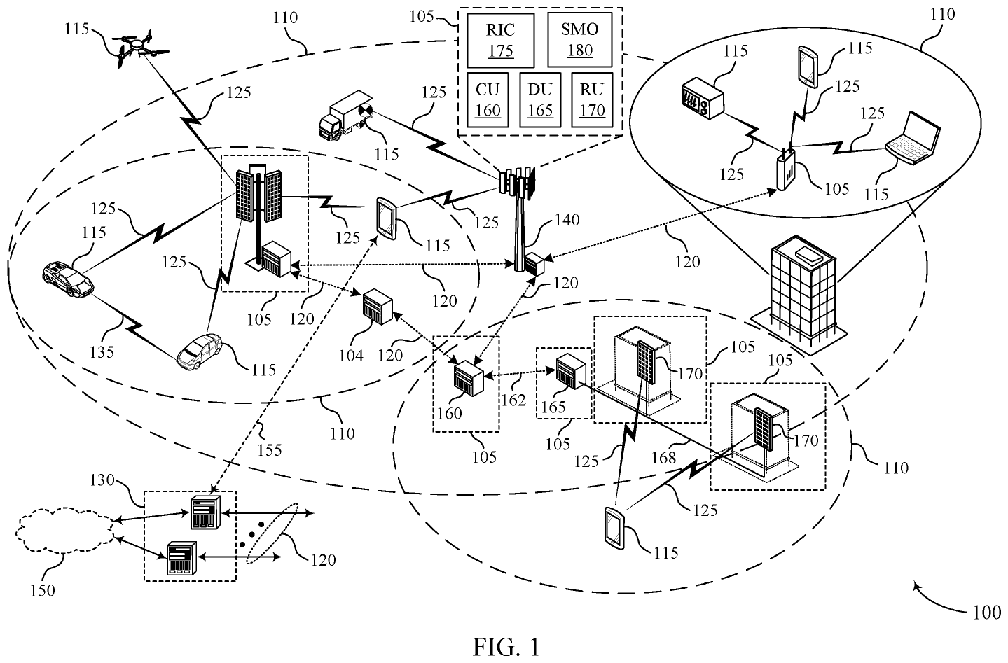

FIG. 1 shows an example of a wireless communications system 100 that supports full-duplex collision handling and beam pairing in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU, such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, the wireless communications system 100 may support NR duplex operations (e.g., full-duplex operations, SFFD, SBFD). The duplex operations may be associated with various deployment scenarios and evaluation methodologies and may impact other operations (e.g., assuming co-existence in co-channel and adjacent channels). In particular, duplex enhancement may be associated with identifying and evaluating potential enhancements to support duplex evolution of NR time division duplexing (TDD) (e.g., dynamic and/or flexible TDD) in an unpaired spectrum. In some cases, the wireless communications system 100 may support SBFD in a TDD carrier or intra-band carrier aggregation (CA) based scenario. Such cases may be associated with simultaneous transmission and reception of downlink signals and uplink signals on a sub-band basis and within a same slot. For instance, a component carrier bandwidth may support one or more downlink sub-bands and one or more uplink sub-bands within a same time resource (e.g., a same slot). Full-duplex communications (e.g., SBFD communications) may provide an increased uplink duty cycle, which may reduce latency. For instance, full-duplex communication may enable communication of an uplink signal in one or more uplink sub-bands in a downlink-only or flexible time resource (e.g., slot), or of a downlink signal in one or more downlink sub-bands in uplink-only time resources, which may enable latency savings and improved uplink coverage. In some cases, full-duplex communications may enhance system capacity, resource utilization, spectrum efficiency, and enable flexible and dynamic uplink/downlink resource adaption (e.g., according to uplink/downlink traffic in a relatively robust manner).

In accordance with one or more aspects of the present disclosure, a wireless communications system 100 may support techniques that enable a first wireless device (e.g., a UE 115, a V2X device, a V2V device) to manage collisions between multiple control indication messages that are received from other wireless devices. Moreover, aspects described herein may enable management of full-duplex beam pair configurations based on receiving control indication messages. In some examples, each wireless communications device may be configured (e.g., by a network entity 105) with respective control indication parameters (e.g., device-specific parameters) for transmitting a control indication message. Thus, a UE 115, or other device, may be able to distinguish colliding control indication messages by associating a given control indication message to a specific wireless device based on corresponding control indication parameters. Each wireless device may also be configured to transmit a priority indication, which may be used to prioritize various communications in accordance with various signaling mechanisms. Additionally, or alternatively, one or more techniques described herein may enable beam management techniques (e.g., for self-interference mitigation) based on receiving a control indication message. For instance, a UE 115 may monitor for a control indication message using a first beam configuration (e.g., a relatively wide beam) and may control (e.g., adjust, modify, update) the first beam configuration in response to receiving the control indication message.

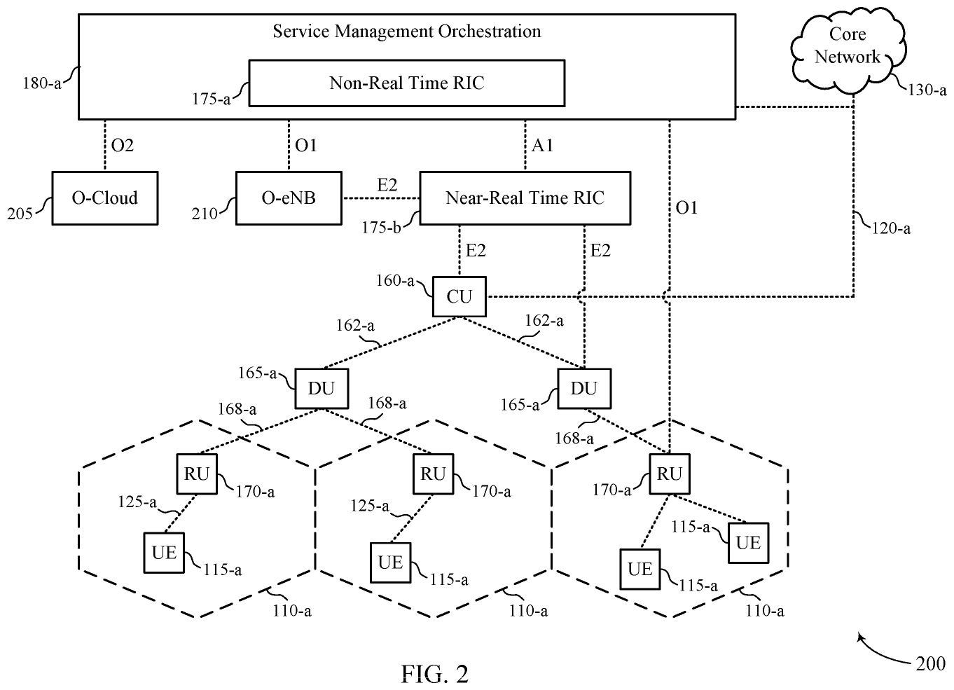

FIG. 2 shows an example of a network architecture 200 (e.g., a disaggregated base station architecture, a disaggregated RAN architecture) that supports full duplex collision handling and beam pairing in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In accordance with one or more aspects of the present disclosure, a network architecture 200 may support techniques that enable a first wireless device (e.g., a UE 115, a DU 165, a CU 160, an RU 170 to manage collisions between multiple control indication messages that are received from other wireless devices. Aspects described herein may also enable management of full-duplex beam pair configurations based on receiving control indication messages. In some examples, each wireless device may be configured (e.g., by a network entity 105, a CU 160, among others) with respective control indication parameters (e.g., device-specific parameters) for transmitting a control indication message. A wireless device may be able to differentiate colliding control indication messages by associating a given control indication message to a specific wireless device based on corresponding control indication parameters. Each wireless device may also be configured to transmit (e.g., via a control indication message) a priority indication, which may be used (e.g., by a receiving device) to prioritize various communications in accordance with various signaling mechanisms. One or more techniques described herein may further enable beam management techniques (e.g., for self-interference mitigation) based on receiving a control indication message. For instance, a wireless device may monitor for a control indication message using a first beam configuration (e.g., a relatively wide beam having a beamwidth above a beamwidth threshold) and may control (e.g., adjust, modify, update) the first beam configuration in response to receiving the control indication message.

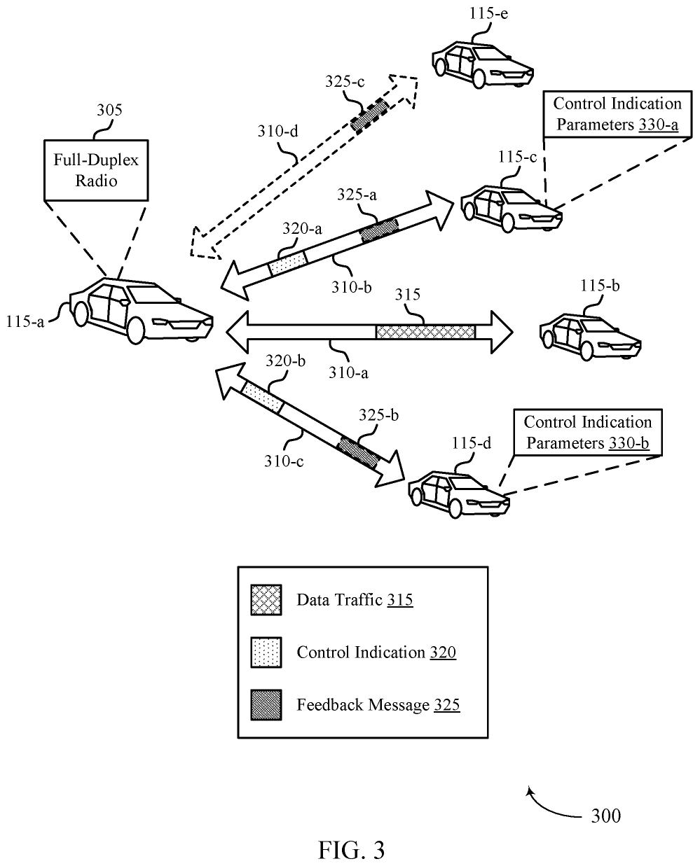

FIG. 3 shows an example of a wireless communications system 300 that supports full-duplex collision handling and beam pairing in accordance with one or more aspects of the present disclosure. The wireless communications system 300 may support sidelink communications (e.g., V2X communications) between various wireless communication devices (e.g., UEs 115, vehicles). Additionally, the wireless communications system 300 may implement or be implemented by aspects of the wireless communications system 100 and the network architecture 200 as described with reference to FIGS. 1 and 2. For example, the wireless communications system 300 may include multiple UEs 115 (e.g., the UE 115-a, the UE 115-b, the UE 115-c, the UE 115-d) which may represent examples of corresponding devices as described with reference to FIGS. 1 and 2. Although the example of FIG. 3 depicts the UE 115-a, the UE 115-b, the UE 115-c, the UE 115-d, and the UE 115-e as vehicle devices (e.g., V2X devices), the techniques described herein may similarly apply for any wireless communication device such as other UEs, network devices (e.g., a network entity 105, a DU 165, an RU 170, a CU 160), or other wireless communication device(s) (e.g., including as described with reference to FIGS. 1 and 2).

In some cases, a UE 115-a (e.g., a V2X device, a sidelink device, a gNB) may communicate with one or more other UEs 115 via respective communication links 310 (e.g., sidelink channels). For instance, the UE 115-a may communicate with a UE 115-b, a UE 115-c, a UE 115-d, and a UE 115-e via a communication link 310-a, a communication link 310-b, a communication link 310-c, and a communication link 310-d respectively. The UE 115-a may be configured for full-duplex communications and may include a full-duplex radio 305, enabling the UE 115-a to transmit (e.g., output, send) first communication signaling and receive (e.g., obtain, monitor for) second communication signaling within a same time resources (e.g., at the same time, simultaneously). Each of the UE 115-b, the UE 115-c, the UE 115-d, and the UE 115-e may respectively support full-duplex communications (e.g., via their own full-duplex radios) or may support half-duplex communications. As described herein, the wireless communications system 300 may support techniques to manage communication collision (e.g., contention) and beam pairing in cellular V2X (C-V2X) applications (e.g., in the absence of a central controller).

In some cases, half-duplex designs may be a constraint in C-V2X applications, particularly when a centralized controller (e.g., a gNB, a CU, a network entity 105) is not present to coordinate transmission and reception scheduling. Such issues may become more severe in cases of mixed traffic, where there may be a relatively large amount of best effort traffic and a relatively small amount of urgent messages (e.g., URLLC data). For instance, the UE 115-a may be transmitting a relatively large amount of data traffic 315 (e.g., best effort traffic) the UE 115-b, and simultaneously, the UE 115-b (e.g., or another UE 115) may have an urgent message to send to the UE 115-a. However, the arrival time of the urgent message from the UE 115-b may not be known beforehand, and the UE 115-a may be continuously monitoring (e.g., using the full-duplex radio 305) for incoming receptions (e.g., even while transmitting the data traffic 315) in order to receive the urgent message.

Additionally, the UE 115-a may be equipped with the full-duplex radio 305 (e.g., an SFFD radio, an SBFD radio) and may be a full-duplex capable device. Full-duplex communications may be associated with self-interference and may present further constraints for the UE 115-a. For instance, a transmission signals by the UE 115-a may interfere with incoming signals that are to be received by the UE 115-a. Further, self-interference may come from other sources, such as signal leakage within the device (e.g., within the internal components of the UE 115-a), signal reflections, and/or clutter associated with the environment in which the wireless communications system 300 is operating. While the UE 115-a is transmitting, the UE 115-a may also use the full-duplex radio 305 to monitor for a control indication 320 (e.g., a control indication signal, a control indication message) from another UE 115 (e.g., the UE 115-c, the UE 115-d). A control indication 320 may be an example of a message that indicates a message transmission request (e.g., an urgent message request, a URLLC transmission request, a request for an urgent transmission to a UE 115 that receives the control indication 320).

In some cases, the UE 115-a may be transmitting data traffic 315 (e.g., a relatively large amount of traffic) to the UE 115-b. At the same time (e.g., or at least partially overlapping in time or within a time window), the UE 115-c and the UE 115-d (e.g., more than one UE 115) may both have urgent messages to send to the UE 115-a. Accordingly, the UE 115-c may transmit a control indication 320-a and the UE 115-d may transmit a control indication 320-b. However, both the control indication 320-a and the control indication 320-b may arrive at the UE 115-a (e.g., be detected by the monitoring of the UE 115-a) at the same time. That is, there may be a collision (e.g., contention) between the control indication 320-a and the control indication 320-b, which may result in a collision between transmission of first urgent data from the UE 115-c and of second urgent data from UE 115-d to the UE 115-a. Additionally, the UE 115-a may not support mechanisms to distinguish between the different control indications 320 nor to prioritize respective transmissions of urgent data from multiple requesting UEs 115.

In accordance with one or more techniques described herein, the UE 115-a may support techniques to determine (e.g., differentiate, distinguish, identify, detect) an association between a given control indication 320 and a specific UE 115 based on one or more control indication parameters 330. For example, in order for the UE 115-a to differentiate between different control indications 320 (e.g., urgent data transmission requests) from different devices (e.g., the UE 115-c and the UE 115-d), a network entity 105 (not shown) (e.g., a gNB or a CU 160) may configure each device of a wireless communications system 300 with unique (e.g., device-specific) control indication parameters 330. That is, the UE 115-c may be configured with a first set of one or more control indication parameters 330-a and the UE 115-d may be configured with a second set of one or more control indication parameters 330-b (e.g., where at least one parameter differs between the control indication parameters 330-a and the control indication parameters 330-b).

Accordingly, the UE 115-c may transmit the control indication 320-a in accordance with the first set of one or more control indication parameters 330-a, and the UE 115-d may transmit the control indication 320-b in accordance with the second set of one or more control indication parameters 330-b. The control indication parameters 330 may include a device-specific control signal (e.g., signal type), a signal sequence, a reference signal, a waveform, a scrambling code, other signaling parameter, or any combination thereof. In some examples, a network entity 105 may additionally, or alternatively, configure each UE 115 a device-specific frequency resources (e.g., specific resource elements (REs)) for transmission of a control indication 320. The device-specific frequency resources (e.g., REs) may be orthogonal in a frequency domain, and thus the collision between the control indication 320-a and the control indication 320-b may be avoided for transmission to the UE 115-a. With device-specific control indication parameters 330, the UE 115-a may be enabled to determine (e.g., recognize, ascertain, or otherwise identify) which UE 115 has an urgent message request.

In some examples, the UE 115-a may receive the control indication 320-a and the control indication 320-b within a same (e.g., at least a partially overlapping) time resource, and both the control indications 320 may indicate respective urgent message transmission requests from the UE 115-c and the UE 115-d. In order to determine which UE 115 (e.g., either the UE 115-c or the UE 115-d) is to transmit (e.g., is allowed to transmit) its urgent message first, a priority indication may be transmitted (e.g., sent) from the UE 115-c and the UE 115-d to the UE 115-a. In some examples, the priority indication may be included in the control signaling (e.g., the control indication 320, request signaling, as an additional or optional value) to enable the UE 115-a to determine a transmission order when a collision between multiple control indications 320 occurs. For instance, the priority indication may include a priority index (e.g., 0, 1, or some other value), and the UE 115-a may determine an order of urgent message transmissions based on a value of the priority index associated with a UE 115. As a non-limiting example, the UE 115-c may indicate a priority 0, the UE 115-d may indicate a priority 1, and the UE 115-a may determine that an urgent message from the UE 115-c is transmitted before an urgent message from the UE 115-d.

After sending a control indication 320, the UE 115-c and/or the UE 115-d may not autonomously (e.g., automatously, automatically) transmit its urgent data message, because the data transmissions may collide (e.g., in this case from the two devices), which may result in a failure to receive the message at the UE 115-a. Accordingly, the UE 115-a may transmit one or more feedback messages 325 (e.g., feedback signaling) to indicate (e.g., grant, command, allow) the UE 115-c or the UE 115-d to transmit its urgent data. The decision by the UE 115-a may be based on the respective priority indications in the control indications 320 (e.g., request signaling). As a non-limiting example, if a first priority indication from the UE 115-c has a relatively higher priority than a second priority indication from the UE 115-d (e.g., data from the UE 115-c has higher priority than data from the UE 115-d), the UE 115-a may send a feedback message 325-a to the UE 115-c that includes an acknowledgment (ACK) message. The UE 115-a may also send a feedback message 325-b to the UE 115-d that includes a not-acknowledgment (NACK) message, thus allowing (e.g., granting, permitting) the UE 115-c to transmit urgent data to the UE 115-a (e.g., before the UE 115-d).

Additionally, or alternatively, the UE 115-a may send a feedback message 325 (e.g., in response to a control indication 320) that indicates an order for transmission (e.g., of the UE 115-c and the UE 115-d), as well as a time resource (e.g., a slot) for the respective UE 115 to transmit its urgent data. For example, the feedback message 325-a may indicate a first slot for the UE 115-c to transmit a first urgent data message, and the feedback message 325-b may indicate a second slot for the UE 115-d to transmit a second urgent data message. The UE 115-a may determine (e.g., decide) the time resources for respective UEs based on the priority indication in the control indications 320 (e.g., request signaling). As a non-limiting example, if a priority of the UE 115-c has a relatively higher priority than a priority of the UE 115-d (e.g., data from the UE 115-c has higher priority than data from the UE 115-d), the feedback message 325-a may indicate the UE 115-c to transmit urgent data in a first slot (e.g., slot 0, a same slot as the feedback message 325-a and/or the control indication 320-a), and the feedback message 325-b may indicate the UE 115-d to transmit urgent data in a second slot (e.g., slot 1, a subsequent slot following a slot including the feedback message 325-b and/or the control indication 320-b).

In some examples, a feedback message 325 may indicate time resources for an urgent data transmission based on one or more bits included in the feedback message 325. For example, a first value of the one or more bits (e.g., “00”) may indicate that a UE 115 (e.g., a UE 115 that receives the feedback message 325) is to transmit urgent data in a same slot that includes the feedback message 325 and/or the control indication 320-a. A second value of the one or more bits (e.g., “01”) may indicate that the UE 115 is to transmit urgent data in a subsequent slot (e.g., the next slot) immediately following the feedback message 325. A third value of the one or more bits (e.g., “10”) may indicate that the UE 115 is to transmit urgent data in a second subsequent slot (e.g., the slot after the next slot) following the feedback message 325. A fourth value of the one or more bits (e.g., “11”) may indicate that the UE 115 is not allowed to transmit urgent data (e.g., no allowed transmission for the UE 115). For instance, in the example of the UE 115-c having a relatively higher priority than the UE 115-d, the UE 115-a may prioritize the urgent data of the UE 115-c by transmitting a first bit value (e.g., “00”) to the UE 115-c via the feedback message 325-a and transmitting a second bit value (e.g., “01”) to the UE 115-d via the feedback message 325-b.

In some additional, or alternative examples, a feedback message 325 from the UE 115-a may indicate an order for transmission of the UE 115-c and the UE 115-d, as well as a time offset (e.g., a back off offset time) for the lower priority UE 115 to transmit its urgent data. The decision of the order of transmission made by the UE 115-a may be based on a priority indication included in a control indication 320 (e.g., the request signaling). As a non-limiting example, if a priority of the UE 115-c has a relatively higher priority than a priority of the UE 115-d, the feedback message 325-a may indicate the UE 115-c to transmit urgent data in a first slot (e.g., a same slot as the feedback message 325-a and/or the control indication 320-a, the feedback message 325-a may include an ACK message), and the feedback message 325-b may indicate the UE 115-d to transmit urgent data after the time offset (e.g., the back off offset). In some examples, the time offset may be associated with (e.g., represented by) a quantity of symbols, a quantity of slots, a quantity of milliseconds, or some other time resource quantity that is indicated in the feedback message 325.

In some examples, the UE 115-a may receive one or more control indications 320 after previously scheduling another transmission of data by another UE 115 (e.g., the UE 115-e). For instance, while the UE 115-a is receiving a control indication 320-a or a control indication 320-b (e.g., or other control signal request), the UE 115-a may have scheduled a data transmission from the UE 115-e in the same slot. In such examples, if the data to be transmitted by the UE 115-e has a higher priority than the data from the UE 115-c and the UE 115-d, the UE 115-a may transmit a NACK message (e.g., or may transmit a bit value of “11”) via both the feedback message 325-a and the feedback message 325-b indicating that no transmission is to be sent from the UE 115-c or the UE 115-d. If the data to be transmitted by the UE 115-e has a lower priority than the data from the UE 115-c and the UE 115-d, the UE 115-a may transmit a feedback message 325-c (e.g., a cancellation message, a fast cancellation indication) to the UE 115-e (e.g., may transmit a bit value of “11”), indicating a cancellation for the scheduled transmission of the UE 115-e. That is, a bit value of a feedback message 325 (e.g., “11”) may be interpreted as “no transmission” for a UE 115-c and a UE 115-d and can be interpreted as a cancellation for the UE 115-e with an existing scheduled data transmission.

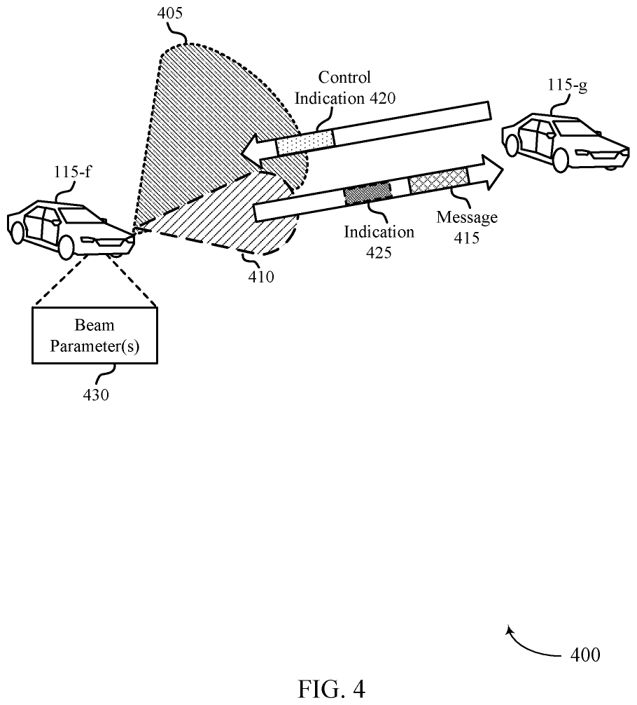

FIG. 4 shows an example of a wireless communications system 400 that supports full-duplex collision handling and beam pairing in accordance with one or more aspects of the present disclosure. The wireless communications system 400 may support sidelink communications (e.g., V2X communications) between various wireless communication devices (e.g., UEs, vehicles). Additionally, the wireless communications system 400 may implement or be implemented by aspects of the wireless communications system 100, the network architecture 200, and the wireless communications system 300 as described with reference to FIGS. 1 through 3. For example, the wireless communications system 400 may include multiple UEs 115 (e.g., the UE 115-f and the UE 115-g) which may represent examples of corresponding devices as described with reference to FIGS. 1 through 3. Although the example of FIG. 4 depicts the UE 115-f and the UE 115-g as vehicles (e.g., V2X devices), the techniques described herein may similarly apply for any wireless communication device such as other UE devices, network devices (e.g., a network entity 105, a DU 165, an RU 170, a CU 160).

The UE 115-f and the UE 115-g may be configured for full-duplex operations. For instance, the UE 115-f may support a beam configuration 405 for receiving (e.g., obtaining, monitoring, detecting) wireless signaling and a beam configuration 410 for transmitting (e.g., outputting, sending, conveying) wireless signaling. In some examples, while the UE 115-f is transmitting (e.g., transmitting a message 415), the UE 115-f may utilize a full-duplex radio (e.g., a full-duplex radio 305, an SFFD radio, an SBFD radio) to monitor for a control indication 420 (e.g., a control indication 320, a control indication signal) from a UE 115-g indicating an urgent message (e.g., URLLC data) transmission request (e.g., the UE 115-g may have an urgent message to transmit to the UE 115-f).

The UE 115-f may utilize a relatively narrow beam for the beam configuration 410 (e.g., a transmit beam, beam 1, a transmit beam associated with a highest reference signal receive power (RSRP) to the UE 115-g), and the UE 115-f may utilize a relatively wide beam for the beam configuration 405 (e.g., an omni or quasi-omni-directional receive beam, a receive beam 3) for reception of the control indication 420. The beam configuration 405 may also be associated with a relatively with low signal to interference and noise ratio (SINR). In some examples, a beam configuration 405 (e.g., a transmission beam) and a beam configuration 410 (e.g., an omni/quasi-omni-directional receive beam) for full-duplex communications may not be feasible (e.g., the beam configuration 410 may create a relatively high level of self-interference at the beam configuration 405). Accordingly, the UE 115-f may apply one or more techniques described herein to reduce self-interference and increase reliability of the full-duplex operation between the UE 115-f and the UE 115-f (e.g., by maintaining transmissions from the UE 115-f to the UE 115-g, while receiving urgent data traffic from the UE 115-g in a full-duplex mode).

In some examples, the UE 115-f may monitor for and receive a control indication 420 via the beam configuration 405. Based on (e.g., in response to) receiving the control indication 420, the UE 115-f may be enabled to apply one or more techniques to determine one or more parameters 430 associated with the beam configuration 405, the beam configuration 410, or both in order to manage the beam pairing (e.g., beam selection). In some examples, the UE 115-f may switch the beam configuration 405 and the beam configuration 410 (e.g., a beam pair) such that the respective beams are associated with reduced self-interference (e.g., a feasible beam pair, the selected beams may be different than a highest-RSRP beam for a half-duplex operation). That is, the UE 115-f may use the beam configuration 405 (e.g., a wide beam) to monitor for a control waveform (e.g., the control indication 420) and then may adjust the beam configuration 405 (e.g., switch to a narrow beam) in response to detecting an incoming waveform.

For example, based on prior beam management (e.g., a prior selection of a beam pair consisting of beam 1 and beam 3), updated beams (e.g., beam 4 and beam 5) may be paired for full-duplex operation at the UE 115-a (e.g., by adjusting one or more parameters 430 associated with the beam configuration 405 and/or the beam configuration 410). Accordingly, the UE 115-f may transmit an indication 425 (e.g., may signal a beam switching indication) to the UE 115-g for corresponding beam switching (e.g., beam switching at the UE 115-g). For example, the UE 115-g may use a reception beam “M” that is quasi co-located with the beam configuration 410 (e.g., beam 4 of the UE 115-f) and may use a transmission beam “N” that is quasi co-located with the beam configuration 405 (e.g., beam 5 of the UE 115-f). Thus, beam “M” and beam “N” at the UE 115-g may be paired for full-duplex operation. After receiving an urgent data message from the UE 115-g, the UE 115-f may adjust the beam configuration 405 (e.g., from a narrow beam to a wide beam) to monitor the control waveform (e.g., for other control indications 420).

Additionally, or alternatively, the UE 115-f may reduce a transmit power parameter associated with the beam configuration 410. For example, the UE 115-f may reduce a transmit power parameter by “X” decibels (dB) to support self-interference mitigation. In some examples, “X” may depend on a level of self-interference (e.g., in accordance with a rule, which may be an industry standard rule). Additionally, or alternatively, the UE 115-f may transmit an indication 425 signals to the UE 115-g to increase (e.g., boost) a transmission power by “Y” dB to improve data reception reliability associated with simultaneous data transmission and reception and to support improved self-interference mitigation.

In some examples, the control indication 420 may be cell-specific or UE-specific (e.g., as described herein, including with reference to FIG. 2). For example, if a network entity 105 (e.g., a gNB) assigns each UE 115 a UE-specific control signal, the UE 115-f may recognize (e.g., determine, identify, detect) the UE 115 (e.g., a device identifier of the UE 115) and may pair with a corresponding full-duplex beam for full-duplex operation with the UE 115 (e.g., a UE 115-g). Moreover, the UE 115-f may stop a transmission (e.g., of a message 415) and switch to a half-duplex operation (e.g., to improve a likelihood that an urgent message is successfully received from the UE 115-g) based on receiving the control indication 420. Additionally, or alternatively, the UE 115-g may switch the beam configuration 405 and the beam configuration 410, reduce a transmit power parameter of the one or more parameters 430 associated with the beam configuration 410, transmit an indication 425 notifying the UE 115-g to increase a transmit power parameter, or any combination thereof, based on receiving the control indication 420 (e.g., a device-specific control indication).

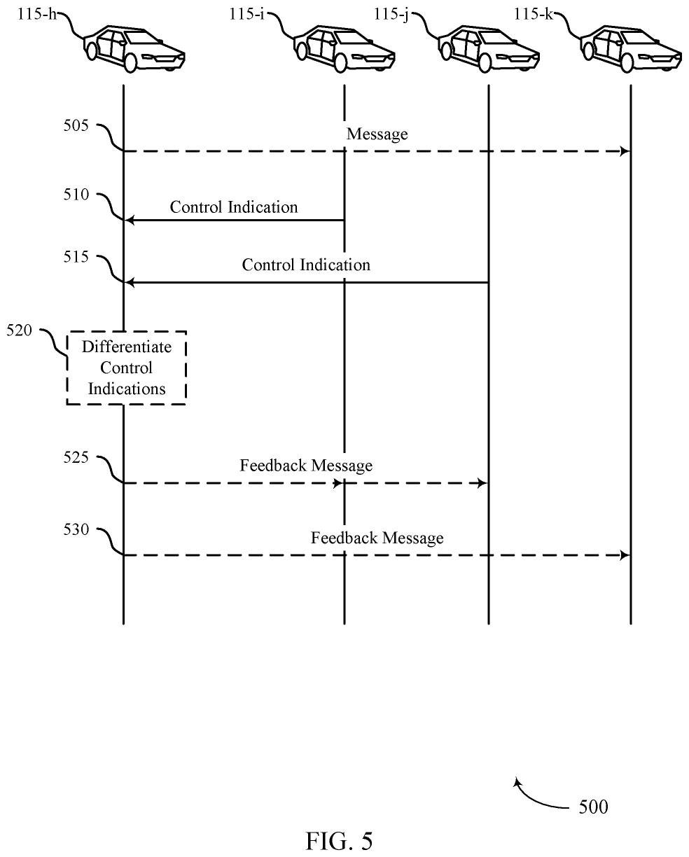

FIG. 5 shows an example of a process flow 500 that supports full-duplex collision handling and beam pairing in accordance with one or more aspects of the present disclosure. In some examples, the process flow 500 may implement aspects of the wireless communications system 100, the wireless communications system 300, the wireless communications system 300, and the wireless communications system 400. For example, the process flow 500 may support signaling between a UE 115-h, a UE 115-i, a UE 115-j, and a UE 115-k. The UEs 115 the process flow 500 may be examples of corresponding devices herein, including with reference to FIGS. 1 through 4. In the following description of the process flow 500, the operations between the UEs 115 may be performed in a different order than the order shown, or other operations may be added or removed from the process flow 500. For example, some operations may also be left out of the process flow 500, or may be performed in different orders or at different times. Further, although some operations or signaling may be shown to occur at different times for discussion purposes, these operations may occur at the same time. Although UEs 115 (e.g., V2X devices, sidelink devices) are shown performing the operations of the process flow 500, one or more aspects of the process flow 500 may additionally, or alternatively be performed by one or more other wireless or network devices (e.g., a network entity 105).

At 505, the UE 115-g may be configured for full-duplex communications (e.g., SFFD, SBFD, may support a full-duplex radio 305), and the UE 115-h may transmit a message (e.g., best effort data traffic, a data traffic 315) to a UE 115-k. The UE 115-k may also simultaneously monitor for one or more control indications from other UEs 115 (e.g., using a full-duplex radio 305).

At 510, the UE 115-h may receive (e.g., while transmitting the message at 505) a first control indication (e.g., a control indication 320, an urgent data transmission request) from a UE 115-i. The first control indication may be associated with a first set of control indication parameters specific to the UE 115-i. The first control indication may include a first request to transmit a message (e.g., an urgent message, URLLC data) from the UE 115-i to the UE 115-h. In some examples, the first set of control indication parameters may include one or more first signal types, one or more first sequence parameters, one or more first reference signal parameters, one or more first waveform parameters, one or more first frequency resources, or any combination thereof.

At 515, the UE 115-h may receive (e.g., at the same time as receiving the first control indication at 510 and while transmitting the message at 505) a second control indication (e.g., a control indication 320) from a UE 115-j. The second control indication may be associated with a second set of control indication parameters specific to the UE 115-j (e.g., different than the first set of control indication parameters). The second control indication may include a second request to transmit a message (e.g., an urgent message, URLLC data) from the UE 115-j to the UE 115-h. In some examples, the second set of control indication parameters may include one or more second signal types, one or more second sequence parameters, one or more second reference signal parameters, one or more second waveform parameters, one or more second frequency resources, or any combination thereof. In some examples, the UE 115-h may receive, via the first control indication, a first priority indication (e.g., a priority index) associated with the UE 115-i, and may receive, via the second control indication, a second priority indication associated with the UE 115-j.

In some examples, the first control indication and the second control indication may be at least partially overlapped in a time domain or may not overlap in the time domain. The first control indication may be orthogonal to the second control indication in a frequency domain based on the first set of control indication parameters and the second set of control indication parameters. The UE 115-h may receive the first control indication and the second control indication via a sidelink channel

At 520, the UE 115-h may differentiate (e.g., determine a different between, distinguish) the first control indication from the second control indication (e.g., or from multiple other control indications). For example, the UE 115 may differentiate the control indications based on a difference of at least one parameter between the first set of control indication parameters and the second set of control indication parameters (e.g., based on the one or more of the respective control indication parameters being device-specific or unique to the UEs 115).

At 525, the UE 115-h may transmit a feedback message (e.g., a feedback message 325) to the UE 115-i, the UE 115-j, or both. The UE 115-h may transmit the feedback message via the sidelink channel. Transmitting the feedback message may be based on the first control indication and the second control indication (e.g., based on differentiating the control indications, based on a determination associated with the respective control indication parameters). The feedback message may indicate whether the UE 115-i, the UE 115-j, or both are to transmit a message to the UE 115-h. The feedback message may be based on respective priority indications of multiple received control indications. In some examples, the UE 115-h may transmit a feedback message indicating that the UE 115-i is to transmit a first message based on determining that the first request (e.g., the first control indication) includes an indication of an urgent message request (e.g., a URLLC message).

The UE 115-h may transmit the feedback message indicating that the UE 115-i is to transmit the first message based on the first priority indication (e.g., of the UE 115-i) being associated with a higher priority than the second priority indication (e.g., of the UE 115-j). In some examples, transmitting the feedback message may include transmitting an ACK message to the UE 115-i indicating that the UE 115-i is to transmit the first message based on a first priority associated with the UE 115-i being higher than a second priority associated with the UE 115-j. The UE 115-h may also transmit a NACK message to the UE 115-j indicating that the UE 115-j is not to transmit the second message.

In some examples, the UE 115-h may transmit, to the UE 115-i (e.g., via a first feedback message), a first indication of first time resources in which the UE 115-i is allowed to transmit a first message. The UE 115-h may also transmit, to the UE 115-j (e.g., via a second feedback message), a second indication of second time resources in which the UE 115-j is to transmit a second message. For example, the first time resources may be before the second time resources in a time domain based on a first priority associated with the UE 115-i being higher than a second priority associated with the UE 115-j. Additionally, or alternatively, the UE 115-h may transmit, via the feedback message, an indication of a time offset after which the UE 115 that receives the feedback message UE 115-j is to transmit a message to the UE 115-h.

At 530, the UE 115-h may have scheduled a transmission of a message from a UE 115-k to the UE 115-h (e.g., prior to receiving the control indications at 510 and 515). The UE 115-h may determine whether the UE 115-k is to continue with its transmission or to cancel its transmission based on respective priorities associated with the UEs 115. For example, the UE 115-h may transmit a first feedback message to the UE 115-i indicating that the UE 115-i is not to transmit a first message based on a priority associated with the UE 115-k being higher than a priority associated with the UE 115-i. The UE 115-h may also transmit a second feedback message to the UE 115-j indicating that the UE 115-j is not to transmit the second message based on the first priority associated with the UE 115-k being higher than a third priority associated with the UE 115-j. Alternatively, the UE 115-h may transmit a cancelation message (e.g., a feedback message including a NACK, a bit value, or other cancelation indication) to the UE 115-k that cancels the transmission of the message from the UE 115-k based on a first priority associated with the UE 115-k being lower than a second priority associated with the UE 115-i or a third priority associated with the UE 115-j.

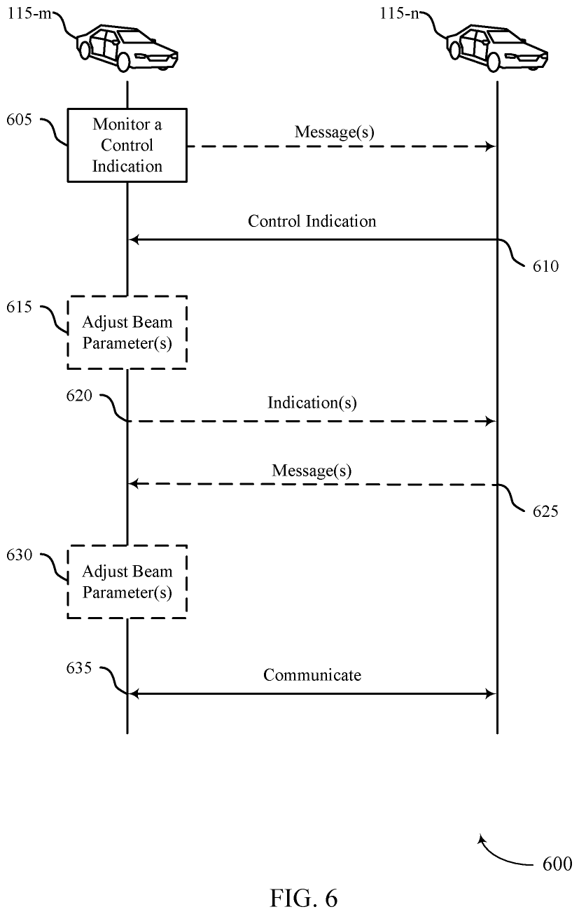

FIG. 6 shows an example of a process flow 600 that supports full-duplex collision handling and beam pairing in accordance with one or more aspects of the present disclosure. In some examples, the process flow 600 may implement aspects of the wireless communications system 100, the wireless communications system 300, the wireless communications system 300, the wireless communications system 400, and the process flow 500. For example, the process flow 600 may support signaling between a UE 115-m and a UE 115-n. The UE 115-m and the UE 115-n of the process flow 600 may be examples of corresponding devices herein, including with reference to FIGS. 1 through 5. In the following description of process flow 600, the operations between the UE 115-m and the UE 115-n may be performed in a different order than the order shown, or other operations may be added or removed from the process flow 600. For example, some operations may also be left out of the process flow 600, or may be performed in different orders or at different times. Further, although some operations or signaling may be shown to occur at different times for discussion purposes, these operations may actually occur at the same time. Although UEs 115 (e.g., V2X devices, sidelink devices) are shown performing the operations of the process flow 600, one or more aspects of the process flow 600 may additionally, or alternatively be performed by one or more other wireless or network devices (e.g., a network entity 105).

At 605, the UE 115-m may monitor, concurrently with transmitting a first message (e.g., a message 415) to a UE 115-n using a first beam configuration (e.g., a beam configuration 410), for a control indication (e.g., a control indication 420, may monitor one or more sidelink channels) from the UE 115-n using a second beam configuration (e.g., a beam configuration 405). The control indication may include a request to transmit a second message from the UE 115-n to the UE 115-m. The UE 115-m and the UE 115-n may be configured for full-duplex communications.

At 610, the UE 115-m may receive the control indication from the UE 115-n based on monitoring. For example, the UE 115-n may have an urgent message to send to the UE 115-m and may transit the control indication to the UE 115-m (e.g., via a sidelink channel).

At 615, the UE 115-m may adjust a first beam parameter of one or more parameters associated with the first beam configuration (e.g., based on receiving the control indication). For example, the UE 115-m may adjust the first beam parameter such that a beam width associated with the first beam configuration decreases (e.g., from a wide beam to a narrow beam). Additionally, or alternatively, the UE 115-m may reduce a transmit power parameter of the one or more parameters associated with the first beam configuration. In some examples, a value of the transmit power parameter (e.g., or a value by which to reduce the transmit power) may be based on a self-interference metric associated with the first beam configuration and the second beam configuration.

At 620, the UE 115-m may transmit an indication of the adjusted beam parameters to the UE 115-n (e.g., based on adjusting the first beam parameter). In some examples, communicating with the UE 115-n may be based transmitting the indication. Additionally, or alternatively, the UE 115-m may transmit an indication (e.g., a command, a request) to the UE 115-n to increase a transmit power parameter of the one or more parameters associated with the second beam configuration. In some examples, a value of the transmit power parameter (e.g., or a value by which to reduce the transmit power) may be based on a self-interference metric associated with the first beam configuration and the second beam configuration.

At 625, the UE 115-m may receive the second message from the UE 115-n based transmitting the indication. The second message may be associated with an urgent message (e.g., URLLC data) That is, the UE 115-n may transmit the second message in accordance with a relatively higher transmit power and/or the UE 115-m may receive the second message from the UE 115-n in accordance with the adjusted beam configuration.

At 630, the UE 115-m may adjust one or more beam parameters associated with the first beam configuration based on receiving the second message. For example, the UE 115-m may adjust the first beam parameter such that a beam width associated with the first beam configuration increases (e.g., from a narrow beam to a wide beam). That is, the UE 115-m may adjust its beam configurations (e.g., beam widths, beam pairing) to receive urgent data from the UE 115-n and may readjust the beam configurations after receiving the urgent data.

At 635, the UE 115-m may communicate with the UE 115-n based on determining (e.g., setting, adjusting, readjusting) the one or more parameters associated with the first beam configuration, the second beam configuration, or both in accordance with receiving the control indication.

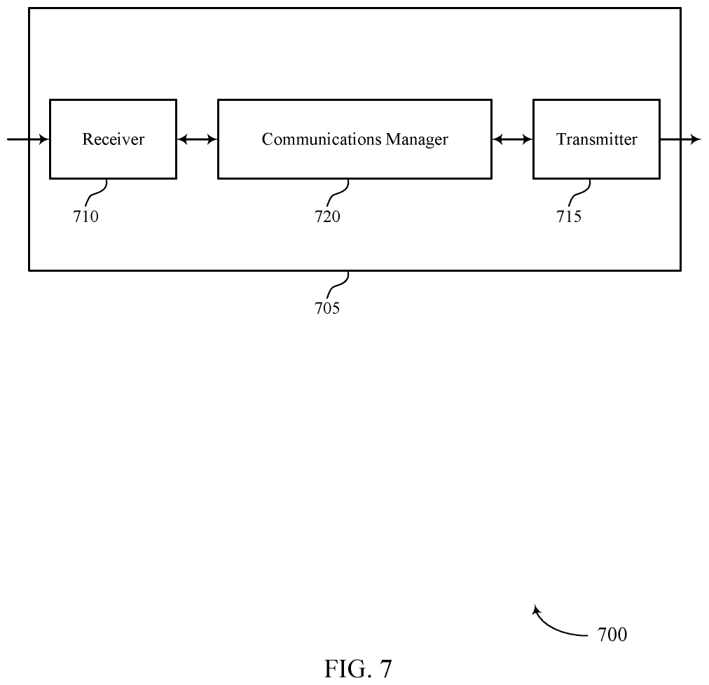

FIG. 7 shows a block diagram 700 of a device 705 that supports full-duplex collision handling and beam pairing in accordance with one or more aspects of the present disclosure. The device 705 may be an example of aspects of a UE 115 or other wireless device as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to full-duplex collision handling and beam pairing). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to full-duplex collision handling and beam pairing). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of full-duplex collision handling and beam pairing as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. The communications manager 720 is capable of, configured to, or operable to support a means for receiving, from a third wireless device, a second control indication associated with a second set of control indication parameters specific to the third wireless device, the second control indication including a second request to transmit a second message from the third wireless device to the first wireless device. The communications manager 720 is capable of, configured to, or operable to support a means for transmitting a feedback message to the second wireless device, the third wireless device, or both based on the first control indication and the second control indication, where the feedback message indicates whether the second wireless device, the third wireless device, or both are to transmit to the first wireless device.

Additionally, or alternatively, the communications manager 720 may support wireless communications in accordance with examples as disclosed herein. For example, the communications manager 720 is capable of, configured to, or operable to support a means for monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications. The communications manager 720 is capable of, configured to, or operable to support a means for receiving the control indication from the second wireless device based on the monitoring. The communications manager 720 is capable of, configured to, or operable to support a means for communicating with the second wireless device based on determining one or more parameters associated with the first beam configuration, the second beam configuration, or both in accordance with receiving the control indication.

Additionally, or alternatively, the communications manager 720 may support wireless communications in accordance with examples as disclosed herein. For example, the communications manager 720 is capable of, configured to, or operable to support a means for transmitting, to a second wireless device, a first control indication associated with a first set of control indication parameters specific to the first wireless device, the first control indication including a first request to transmit a first message from the first wireless device to the second wireless device. The communications manager 720 is capable of, configured to, or operable to support a means for receiving a feedback message from the second wireless device based on the first control indication, where the feedback message indicates whether the second wireless device is to transmit the first message to the second wireless device.

Additionally, or alternatively, the communications manager 720 may support wireless communications in accordance with examples as disclosed herein. For example, the communications manager 720 is capable of, configured to, or operable to support a means for transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications. The communications manager 720 is capable of, configured to, or operable to support a means for communicating with the second wireless device based on one or more parameters associated with the first beam configuration, the second beam configuration, or both in accordance with transmitting the control indication.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources, among other benefits.

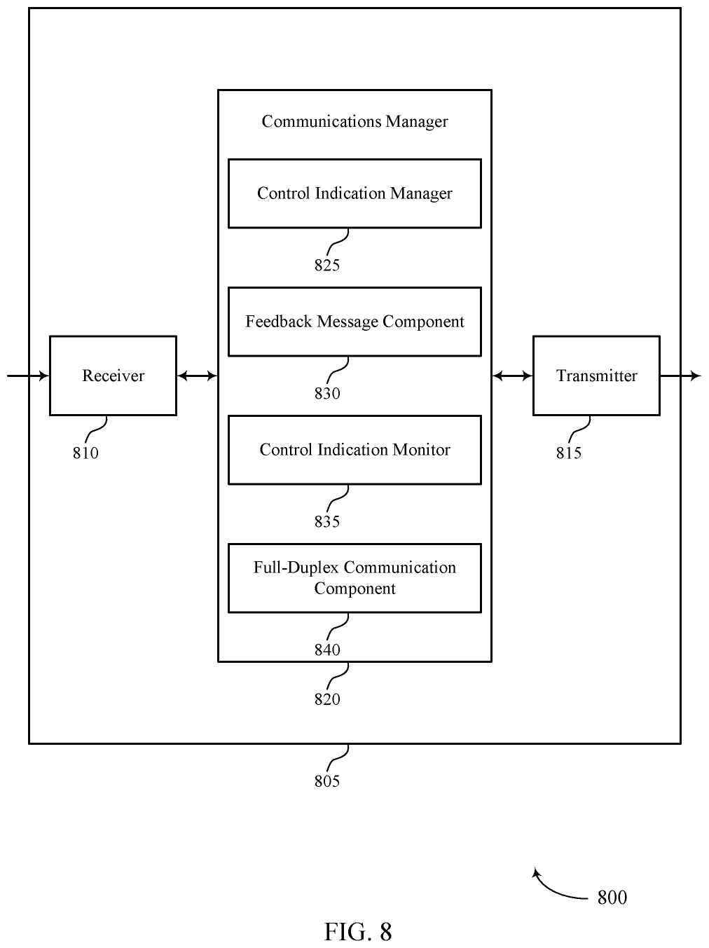

FIG. 8 shows a block diagram 800 of a device 805 that supports full-duplex collision handling and beam pairing in accordance with one or more aspects of the present disclosure. The device 805 may be an example of aspects of a device 705 or a UE 115 or other wireless device as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to full-duplex collision handling and beam pairing). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to full-duplex collision handling and beam pairing). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of full-duplex collision handling and beam pairing as described herein. For example, the communications manager 820 may include a control indication manager 825, a feedback message component 830, a control indication monitor 835, a full-duplex communication component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control indication manager 825 is capable of, configured to, or operable to support a means for receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. The control indication manager 825 is capable of, configured to, or operable to support a means for receiving, from a third wireless device, a second control indication associated with a second set of control indication parameters specific to the third wireless device, the second control indication including a second request to transmit a second message from the third wireless device to the first wireless device. The feedback message component 830 is capable of, configured to, or operable to support a means for transmitting a feedback message to the second wireless device, the third wireless device, or both based on the first control indication and the second control indication, where the feedback message indicates whether the second wireless device, the third wireless device, or both are to transmit to the first wireless device.

Additionally, or alternatively, the communications manager 820 may support wireless communications in accordance with examples as disclosed herein. The control indication monitor 835 is capable of, configured to, or operable to support a means for monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications. The control indication manager 825 is capable of, configured to, or operable to support a means for receiving the control indication from the second wireless device based on the monitoring. The full-duplex communication component 840 is capable of, configured to, or operable to support a means for communicating with the second wireless device based on determining one or more parameters associated with the first beam configuration, the second beam configuration, or both in accordance with receiving the control indication.

Additionally, or alternatively, the communications manager 820 may support wireless communications in accordance with examples as disclosed herein. The control indication manager 825 is capable of, configured to, or operable to support a means for transmitting, to a second wireless device, a first control indication associated with a first set of control indication parameters specific to the first wireless device, the first control indication including a first request to transmit a first message from the first wireless device to the second wireless device. The feedback message component 830 is capable of, configured to, or operable to support a means for receiving a feedback message from the second wireless device based on the first control indication, where the feedback message indicates whether the second wireless device is to transmit the first message to the second wireless device.

Additionally, or alternatively, the communications manager 820 may support wireless communications in accordance with examples as disclosed herein. The control indication manager 825 is capable of, configured to, or operable to support a means for transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications. The full-duplex communication component 840 is capable of, configured to, or operable to support a means for communicating with the second wireless device based on one or more parameters associated with the first beam configuration, the second beam configuration, or both in accordance with transmitting the control indication.

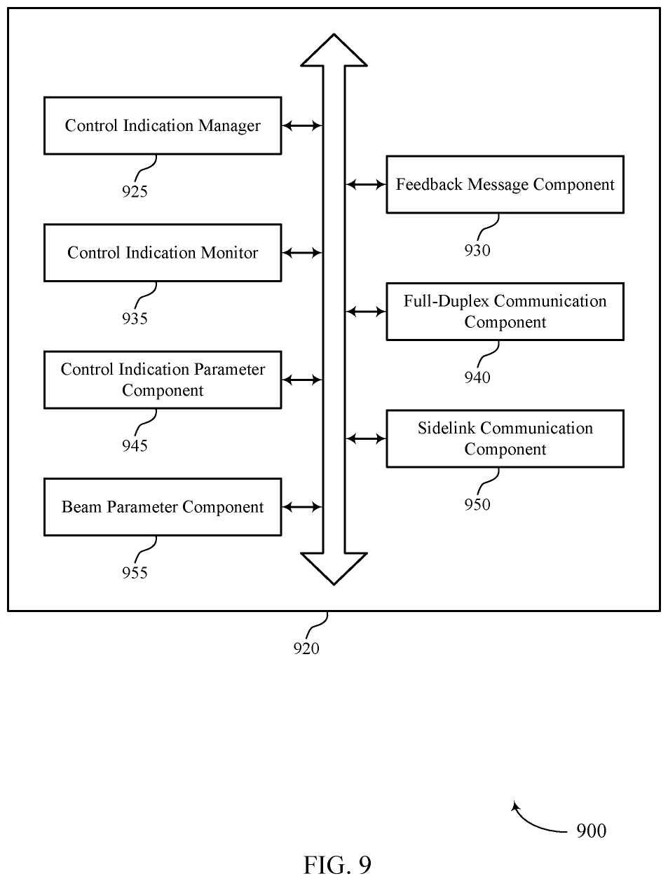

FIG. 9 shows a block diagram 900 of a communications manager 920 that supports full-duplex collision handling and beam pairing in accordance with one or more aspects of the present disclosure. The communications manager 920 may be an example of aspects of a communications manager 720, a communications manager 820, or both, as described herein. The communications manager 920, or various components thereof, may be an example of means for performing various aspects of full-duplex collision handling and beam pairing as described herein. For example, the communications manager 920 may include a control indication manager 925, a feedback message component 930, a control indication monitor 935, a full-duplex communication component 940, a control indication parameter component 945, a sidelink communication component 950, a beam parameter component 955, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The control indication manager 925 is capable of, configured to, or operable to support a means for receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. In some examples, the control indication manager 925 is capable of, configured to, or operable to support a means for receiving, from a third wireless device, a second control indication associated with a second set of control indication parameters specific to the third wireless device, the second control indication including a second request to transmit a second message from the third wireless device to the first wireless device. The feedback message component 930 is capable of, configured to, or operable to support a means for transmitting a feedback message to the second wireless device, the third wireless device, or both based on the first control indication and the second control indication, where the feedback message indicates whether the second wireless device, the third wireless device, or both are to transmit to the first wireless device.

In some examples, the first set of control indication parameters includes one or more first signal types, one or more first sequence parameters, one or more first reference signal parameters, one or more first waveform parameters, one or more first frequency resources, or any combination thereof. In some examples, the second set of control indication parameters includes one or more second signal types, one or more second sequence parameters, one or more second reference signal parameters, one or more second waveform parameters, one or more second frequency resources, or any combination thereof.

In some examples, the control indication parameter component 945 is capable of, configured to, or operable to support a means for differentiating the first control indication from the second control indication based on a difference of at least one parameter between the first set of control indication parameters and the second set of control indication parameters.

In some examples, to support transmitting the feedback message to the second wireless device, the feedback message component 930 is capable of, configured to, or operable to support a means for transmitting the feedback message indicating that the second wireless device is to transmit the first message based on determining that the first request includes an indication of an urgent message request.

In some examples, the first control indication and the second control indication are at least partially overlapped in a time domain, and the control indication manager 925 is capable of, configured to, or operable to support a means for receiving, via the first control indication, a first priority indication associated with the second wireless device. In some examples, the first control indication and the second control indication are at least partially overlapped in a time domain, and the control indication manager 925 is capable of, configured to, or operable to support a means for receiving, via the second control indication, a second priority indication associated with the third wireless device. In some examples, the first control indication and the second control indication are at least partially overlapped in a time domain, and the feedback message component 930 is capable of, configured to, or operable to support a means for transmitting the feedback message indicating that the second wireless device is to transmit the first message based on the first priority indication being associated with a higher priority than the second priority indication.

In some examples, the first control indication is orthogonal to the second control indication in a frequency domain based on the first set of control indication parameters and the second set of control indication parameters.

In some examples, to support transmitting the feedback message, the feedback message component 930 is capable of, configured to, or operable to support a means for transmitting an acknowledgment message to the second wireless device indicating that the second wireless device is to transmit the first message based on a first priority associated with the second wireless device being higher than a second priority associated with the third wireless device. In some examples, to support transmitting the feedback message, the feedback message component 930 is capable of, configured to, or operable to support a means for transmitting a not-acknowledgment message to the third wireless device indicating that the third wireless device is not to transmit the second message.

In some examples, to support transmitting the feedback message, the feedback message component 930 is capable of, configured to, or operable to support a means for transmitting, to the second wireless device, a first indication of first time resources in which the second wireless device is allowed to transmit the first message. In some examples, to support transmitting the feedback message, the feedback message component 930 is capable of, configured to, or operable to support a means for transmitting, to the third wireless device, a second indication of second time resources in which the third wireless device is to transmit the second message, where the first time resources are before the second time resources in a time domain based on a first priority associated with the second wireless device being higher than a second priority associated with the third wireless device.

In some examples, to support transmitting the feedback message, the feedback message component 930 is capable of, configured to, or operable to support a means for transmitting an acknowledgment message to the second wireless device indicating that the second wireless device is to transmit the first message based on a first priority associated with the second wireless device being higher than a second priority associated with the third wireless device. In some examples, to support transmitting the feedback message, the feedback message component 930 is capable of, configured to, or operable to support a means for transmitting, to the third wireless device, an indication of a time offset after which the third wireless device is to transmit the second message.

In some examples, the first wireless device has scheduled a transmission of a third message from a fourth wireless device to the first wireless device, and the feedback message component 930 is capable of, configured to, or operable to support a means for transmitting the feedback message to the second wireless device indicating that the second wireless device is not to transmit the first message based on a first priority associated with the fourth wireless device being higher than a second priority associated with the second wireless device. In some examples, the first wireless device has scheduled a transmission of a third message from a fourth wireless device to the first wireless device, and the feedback message component 930 is capable of, configured to, or operable to support a means for transmitting a second feedback message to the third wireless device indicating that the third wireless device is not to transmit the second message based on the first priority associated with the fourth wireless device being higher than a third priority associated with the third wireless device.

In some examples, the first wireless device has scheduled a transmission of a third message from a fourth wireless device to the first wireless device, and the feedback message component 930 is capable of, configured to, or operable to support a means for transmitting a cancelation message to the fourth wireless device that cancels the transmission of the third message based on a first priority associated with the fourth wireless device being lower than a second priority associated with the second wireless device or a third priority associated with the third wireless device.

In some examples, the sidelink communication component 950 is capable of, configured to, or operable to support a means for receiving the first control indication and the second control indication via a sidelink channel. In some examples, the sidelink communication component 950 is capable of, configured to, or operable to support a means for transmitting the feedback message via the sidelink channel.

In some examples, the full-duplex communication component 940 is capable of, configured to, or operable to support a means for transmitting a third message to a fourth wireless device, where the first control indication and the second control indication are received simultaneously with transmitting the third message.

Additionally, or alternatively, the communications manager 920 may support wireless communications in accordance with examples as disclosed herein. The control indication monitor 935 is capable of, configured to, or operable to support a means for monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications. In some examples, the control indication manager 925 is capable of, configured to, or operable to support a means for receiving the control indication from the second wireless device based on the monitoring. The full-duplex communication component 940 is capable of, configured to, or operable to support a means for communicating with the second wireless device based on determining one or more parameters associated with the first beam configuration, the second beam configuration, or both in accordance with receiving the control indication.

In some examples, the beam parameter component 955 is capable of, configured to, or operable to support a means for adjusting a first beam parameter of the one or more parameters associated with the first beam configuration, where a beam width associated with the first beam configuration decreases based on receiving the control indication. In some examples, the beam parameter component 955 is capable of, configured to, or operable to support a means for transmitting an indication of the first beam parameter to the second wireless device based on adjusting the first beam parameter, where communicating with the second wireless device is based on transmitting the indication.

In some examples, the full-duplex communication component 940 is capable of, configured to, or operable to support a means for receiving the second message from the second wireless device based on transmitting the indication. In some examples, the beam parameter component 955 is capable of, configured to, or operable to support a means for adjusting the first beam parameter of the one or more parameters associated with the first beam configuration, where the beam width associated with the first beam configuration increases based on receiving the second message.

In some examples, the beam parameter component 955 is capable of, configured to, or operable to support a means for reducing a transmit power parameter of the one or more parameters associated with the first beam configuration, where a value of the transmit power parameter is based on a self-interference metric associated with the first beam configuration and the second beam configuration.

In some examples, the beam parameter component 955 is capable of, configured to, or operable to support a means for transmitting an indication to the second wireless device to increase a transmit power parameter of the one or more parameters associated with the second beam configuration, where a value of the transmit power parameter is based on a self-interference metric associated with the first beam configuration and the second beam configuration.

Additionally, or alternatively, the communications manager 920 may support wireless communications in accordance with examples as disclosed herein. In some examples, the control indication manager 925 is capable of, configured to, or operable to support a means for transmitting, to a second wireless device, a first control indication associated with a first set of control indication parameters specific to the first wireless device, the first control indication including a first request to transmit a first message from the first wireless device to the second wireless device. In some examples, the feedback message component 930 is capable of, configured to, or operable to support a means for receiving a feedback message from the second wireless device based on the first control indication, where the feedback message indicates whether the second wireless device is to transmit the first message to the second wireless device.

In some examples, the first set of control indication parameters includes one or more first signal types, one or more first sequence parameters, one or more first reference signal parameters, one or more first waveform parameters, one or more first frequency resources, or any combination thereof.

In some examples, to support receiving the feedback message from the second wireless device, the feedback message component 930 is capable of, configured to, or operable to support a means for receiving the feedback message indicating that the first wireless device is to transmit the first message based on the first request including an indication of an urgent message request.

In some examples, the control indication manager 925 is capable of, configured to, or operable to support a means for transmitting, via the first control indication, a first priority indication associated with the first wireless device. In some examples, the feedback message component 930 is capable of, configured to, or operable to support a means for receiving the feedback message indicating that the first wireless device is to transmit the first message based on the first priority indication.

In some examples, the first control indication is orthogonal to a second control indication from another wireless device in a frequency domain based on the first set of control indication parameters.

In some examples, to support receiving the feedback message, the feedback message component 930 is capable of, configured to, or operable to support a means for receiving an acknowledgment message or a not-acknowledgment message from the second wireless device indicating whether the first wireless device is to transmit the first message based on a first priority associated with the first wireless device.

In some examples, to support receiving the feedback message, the feedback message component 930 is capable of, configured to, or operable to support a means for receiving, from the second wireless device, a first indication of first time resources in which the first wireless device is allowed to transmit the first message, where the first time resources are based on a first priority associated with the first wireless device.

In some examples, to support receiving the feedback message, the feedback message component 930 is capable of, configured to, or operable to support a means for receiving an indication of a time offset after which the first wireless device is to transmit the first message.

In some examples, the sidelink communication component 950 is capable of, configured to, or operable to support a means for transmitting the first control indication via a sidelink channel. In some examples, the sidelink communication component 950 is capable of, configured to, or operable to support a means for receiving the feedback message via the sidelink channel.

In some examples, the first wireless device is configured for full-duplex communications.

Additionally, or alternatively, the communications manager 920 may support wireless communications in accordance with examples as disclosed herein. In some examples, the control indication manager 925 is capable of, configured to, or operable to support a means for transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications. In some examples, the full-duplex communication component 940 is capable of, configured to, or operable to support a means for communicating with the second wireless device based on one or more parameters associated with the first beam configuration, the second beam configuration, or both in accordance with transmitting the control indication.

In some examples, the beam parameter component 955 is capable of, configured to, or operable to support a means for receiving an indication of a first beam parameter from the second wireless device based on transmitting the control indication, where a beam width associated with the first beam configuration decreases based on receiving the indication.

In some examples, the beam parameter component 955 is capable of, configured to, or operable to support a means for transmitting the second message to the second wireless device based on receiving the indication, where the beam width associated with the first beam configuration increases based on transmitting the second message.

In some examples, the beam parameter component 955 is capable of, configured to, or operable to support a means for receiving an indication from the second wireless device to increase a transmit power parameter of the one or more parameters associated with the second beam configuration, where a value of the transmit power parameter is based on a self-interference metric associated with the first beam configuration and the second beam configuration.

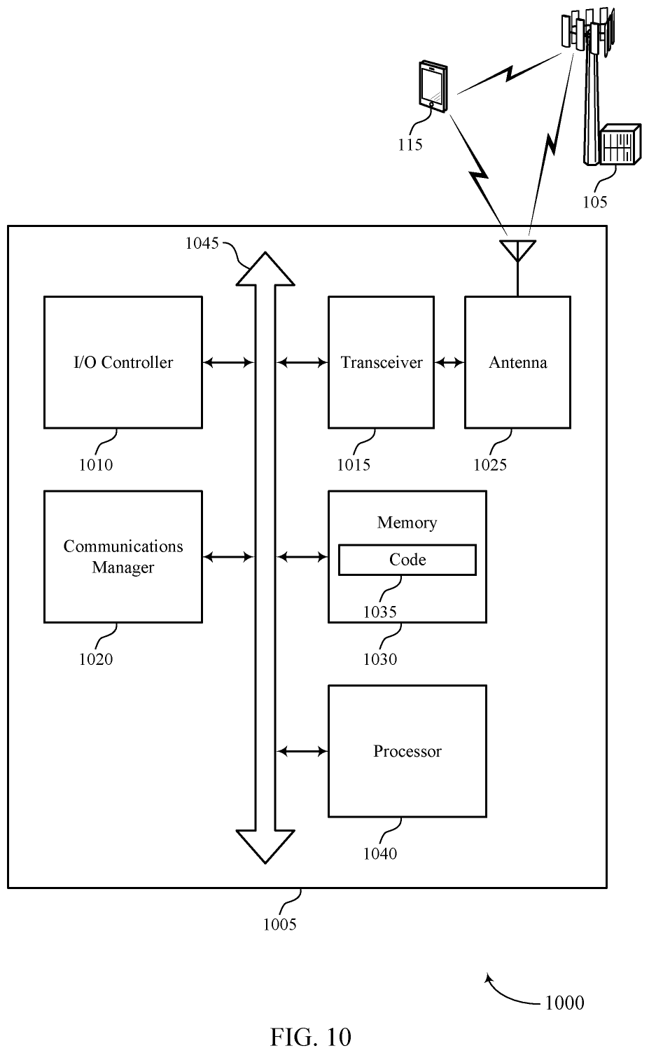

FIG. 10 shows a diagram of a system 1000 including a device 1005 that supports full-duplex collision handling and beam pairing in accordance with one or more aspects of the present disclosure. The device 1005 may be an example of or include components of a device 705, a device 805, a UE 115, or a wireless device as described herein. The device 1005 may include components for bi-directional voice and data communications including components for transmitting and receiving communications, such as a communications manager 1020, an I/O controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include RAM and ROM. The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a BIOS which may control basic hardware or software operation such as the interaction with peripheral components or devices.

The at least one processor 1040 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting full-duplex collision handling and beam pairing). For example, the device 1005 or a component of the device 1005 may include at least one processor 1040 and at least one memory 1030 coupled with or to the at least one processor 1040, the at least one processor 1040 and the at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. The communications manager 1020 is capable of, configured to, or operable to support a means for receiving, from a third wireless device, a second control indication associated with a second set of control indication parameters specific to the third wireless device, the second control indication including a second request to transmit a second message from the third wireless device to the first wireless device. The communications manager 1020 is capable of, configured to, or operable to support a means for transmitting a feedback message to the second wireless device, the third wireless device, or both based on the first control indication and the second control indication, where the feedback message indicates whether the second wireless device, the third wireless device, or both are to transmit to the first wireless device.

Additionally, or alternatively, the communications manager 1020 may support wireless communications in accordance with examples as disclosed herein. For example, the communications manager 1020 is capable of, configured to, or operable to support a means for monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications. The communications manager 1020 is capable of, configured to, or operable to support a means for receiving the control indication from the second wireless device based on the monitoring. The communications manager 1020 is capable of, configured to, or operable to support a means for communicating with the second wireless device based on determining one or more parameters associated with the first beam configuration, the second beam configuration, or both in accordance with receiving the control indication.

Additionally, or alternatively, the communications manager 1020 may support wireless communications in accordance with examples as disclosed herein. For example, the communications manager 1020 is capable of, configured to, or operable to support a means for transmitting, to a second wireless device, a first control indication associated with a first set of control indication parameters specific to the first wireless device, the first control indication including a first request to transmit a first message from the first wireless device to the second wireless device. The communications manager 1020 is capable of, configured to, or operable to support a means for receiving a feedback message from the second wireless device based on the first control indication, where the feedback message indicates whether the second wireless device is to transmit the first message to the second wireless device.

Additionally, or alternatively, the communications manager 1020 may support wireless communications in accordance with examples as disclosed herein. For example, the communications manager 1020 is capable of, configured to, or operable to support a means for transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications. The communications manager 1020 is capable of, configured to, or operable to support a means for communicating with the second wireless device based on one or more parameters associated with the first beam configuration, the second beam configuration, or both in accordance with transmitting the control indication.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of full-duplex collision handling and beam pairing as described herein, or the at least one processor 1040 and the at least one memory 1030 may be otherwise configured to, individually or collectively, perform or support such operations.

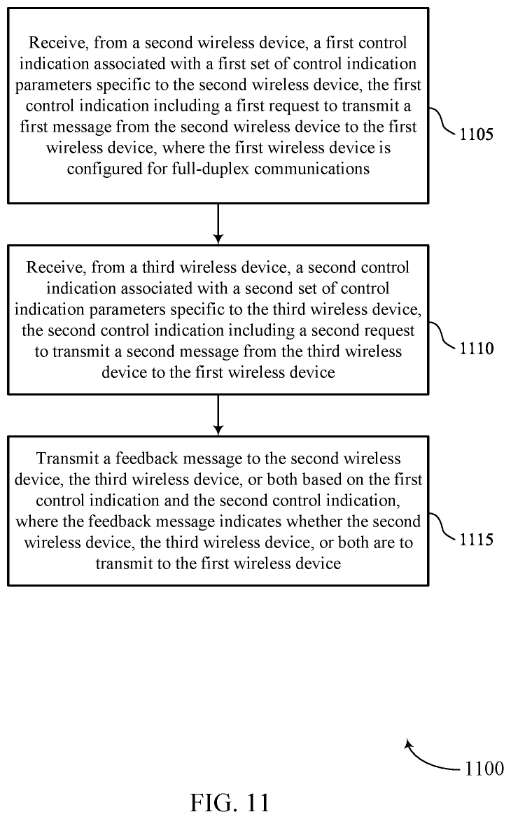

FIG. 11 shows a flowchart illustrating a method 1100 that supports full-duplex collision handling and beam pairing in accordance with one or more aspects of the present disclosure. The operations of the method 1100 may be implemented by a UE, a wireless device, or its components as described herein. For example, the operations of the method 1100 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1105, the method may include receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. The operations of 1105 may be performed in accordance with examples as disclosed herein. In some examples, aspects of the operations of 1105 may be performed by a control indication manager 925 as described with reference to FIG. 9.

At 1110, the method may include receiving, from a third wireless device, a second control indication associated with a second set of control indication parameters specific to the third wireless device, the second control indication including a second request to transmit a second message from the third wireless device to the first wireless device. The operations of 1110 may be performed in accordance with examples as disclosed herein. In some examples, aspects of the operations of 1110 may be performed by a control indication manager 925 as described with reference to FIG. 9.

At 1115, the method may include transmitting a feedback message to the second wireless device, the third wireless device, or both based on the first control indication and the second control indication, where the feedback message indicates whether the second wireless device, the third wireless device, or both are to transmit to the first wireless device. The operations of 1115 may be performed in accordance with examples as disclosed herein. In some examples, aspects of the operations of 1115 may be performed by a feedback message component 930 as described with reference to FIG. 9.

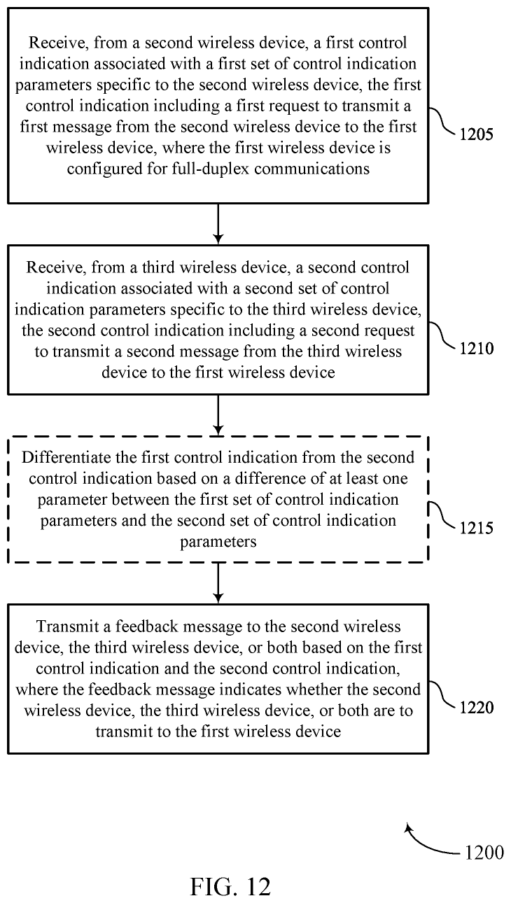

FIG. 12 shows a flowchart illustrating a method 1200 that supports full-duplex collision handling and beam pairing in accordance with one or more aspects of the present disclosure. The operations of the method 1200 may be implemented by a UE, a wireless device, or its components as described herein. For example, the operations of the method 1200 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1205, the method may include receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. The operations of 1205 may be performed in accordance with examples as disclosed herein. In some examples, aspects of the operations of 1205 may be performed by a control indication manager 925 as described with reference to FIG. 9.

At 1210, the method may include receiving, from a third wireless device, a second control indication associated with a second set of control indication parameters specific to the third wireless device, the second control indication including a second request to transmit a second message from the third wireless device to the first wireless device. The operations of 1210 may be performed in accordance with examples as disclosed herein. In some examples, aspects of the operations of 1210 may be performed by a control indication manager 925 as described with reference to FIG. 9.

At 1215, in some examples, the method may include differentiating the first control indication from the second control indication based on a difference of at least one parameter between the first set of control indication parameters and the second set of control indication parameters. The operations of 1215 may be performed in accordance with examples as disclosed herein. In some examples, aspects of the operations of 1215 may be performed by a control indication parameter component 945 as described with reference to FIG. 9.

At 1220, the method may include transmitting a feedback message to the second wireless device, the third wireless device, or both based on the first control indication and the second control indication, where the feedback message indicates whether the second wireless device, the third wireless device, or both are to transmit to the first wireless device. The operations of 1220 may be performed in accordance with examples as disclosed herein. In some examples, aspects of the operations of 1220 may be performed by a feedback message component 930 as described with reference to FIG. 9.

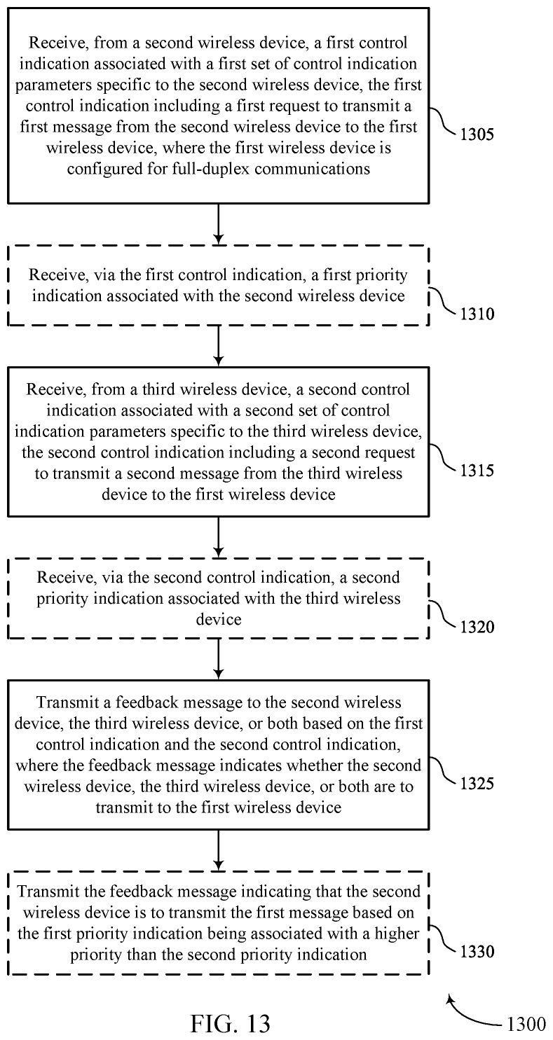

FIG. 13 shows a flowchart illustrating a method 1300 that supports full-duplex collision handling and beam pairing in accordance with one or more aspects of the present disclosure. The operations of the method 1300 may be implemented by a UE, a wireless device, or its components as described herein. For example, the operations of the method 1300 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1305, the method may include receiving, from a second wireless device, a first control indication associated with a first set of control indication parameters specific to the second wireless device, the first control indication including a first request to transmit a first message from the second wireless device to the first wireless device, where the first wireless device is configured for full-duplex communications. The operations of 1305 may be performed in accordance with examples as disclosed herein. In some examples, aspects of the operations of 1305 may be performed by a control indication manager 925 as described with reference to FIG. 9.

At 1310, in some examples, the method may include receiving, via the first control indication, a first priority indication associated with the second wireless device. The operations of 1310 may be performed in accordance with examples as disclosed herein. In some examples, aspects of the operations of 1310 may be performed by a control indication manager 925 as described with reference to FIG. 9.

At 1315, the method may include receiving, from a third wireless device, a second control indication associated with a second set of control indication parameters specific to the third wireless device, the second control indication including a second request to transmit a second message from the third wireless device to the first wireless device. The operations of 1315 may be performed in accordance with examples as disclosed herein. In some examples, aspects of the operations of 1315 may be performed by a control indication manager 925 as described with reference to FIG. 9.

At 1320, in some examples, the method may include receiving, via the second control indication, a second priority indication associated with the third wireless device. The operations of 1320 may be performed in accordance with examples as disclosed herein. In some examples, aspects of the operations of 1320 may be performed by a control indication manager 925 as described with reference to FIG. 9.

At 1325, the method may include transmitting a feedback message to the second wireless device, the third wireless device, or both based on the first control indication and the second control indication, where the feedback message indicates whether the second wireless device, the third wireless device, or both are to transmit to the first wireless device. The operations of 1325 may be performed in accordance with examples as disclosed herein. In some examples, aspects of the operations of 1325 may be performed by a feedback message component 930 as described with reference to FIG. 9.

At 1330, in some examples, the method may include transmitting the feedback message indicating that the second wireless device is to transmit the first message based on the first priority indication being associated with a higher priority than the second priority indication. The operations of 1330 may be performed in accordance with examples as disclosed herein. In some examples, aspects of the operations of 1330 may be performed by a feedback message component 930 as described with reference to FIG. 9.

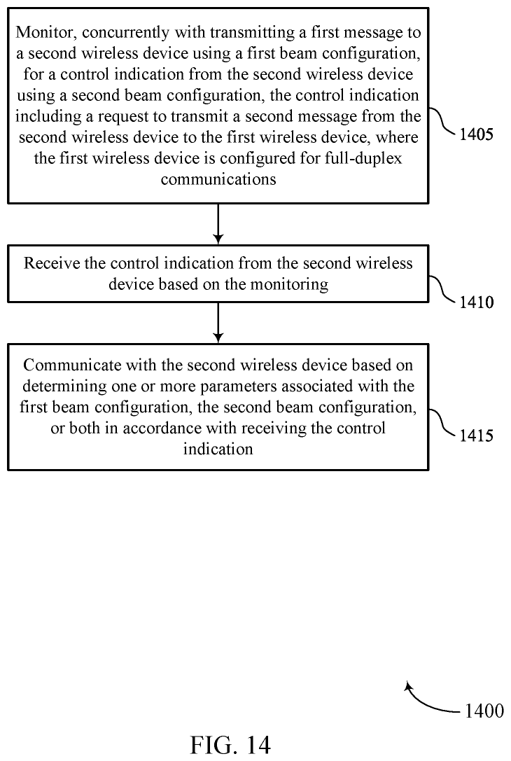

FIG. 14 shows a flowchart illustrating a method 1400 that supports full-duplex collision handling and beam pairing in accordance with one or more aspects of the present disclosure. The operations of the method 1400 may be implemented by a UE, a wireless device, or its components as described herein. For example, the operations of the method 1400 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1405, the method may include monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications. The operations of 1405 may be performed in accordance with examples as disclosed herein. In some examples, aspects of the operations of 1405 may be performed by a control indication monitor 935 as described with reference to FIG. 9.

At 1410, the method may include receiving the control indication from the second wireless device based on the monitoring. The operations of 1410 may be performed in accordance with examples as disclosed herein. In some examples, aspects of the operations of 1410 may be performed by a control indication manager 925 as described with reference to FIG. 9.

At 1415, the method may include communicating with the second wireless device based on determining one or more parameters associated with the first beam configuration, the second beam configuration, or both in accordance with receiving the control indication. The operations of 1415 may be performed in accordance with examples as disclosed herein. In some examples, aspects of the operations of 1415 may be performed by a full-duplex communication component 940 as described with reference to FIG. 9.

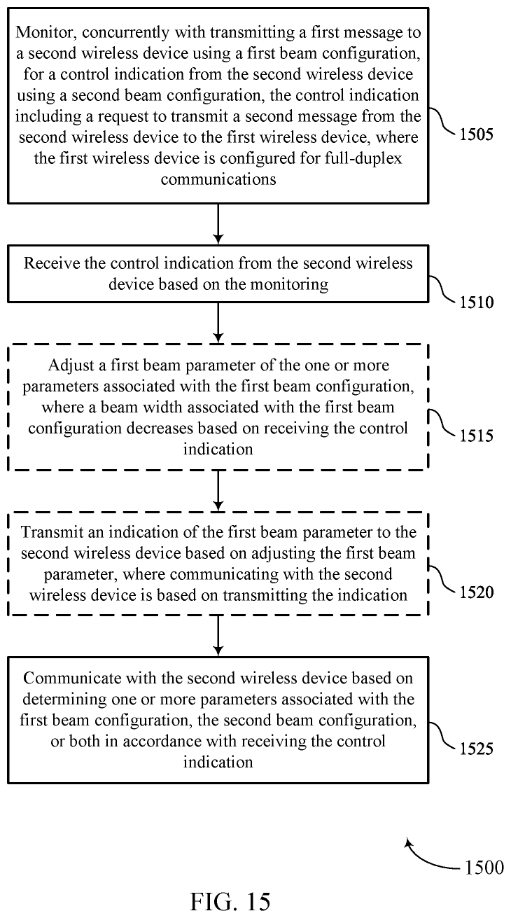

FIG. 15 shows a flowchart illustrating a method 1500 that supports full-duplex collision handling and beam pairing in accordance with one or more aspects of the present disclosure. The operations of the method 1500 may be implemented by a UE, a wireless device, or its components as described herein. For example, the operations of the method 1500 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1505, the method may include monitoring, concurrently with transmitting a first message to a second wireless device using a first beam configuration, for a control indication from the second wireless device using a second beam configuration, the control indication including a request to transmit a second message from the second wireless device to the first wireless device, where the first wireless device is configured for full-duplex communications. The operations of 1505 may be performed in accordance with examples as disclosed herein. In some examples, aspects of the operations of 1505 may be performed by a control indication monitor 935 as described with reference to FIG. 9.

At 1510, the method may include receiving the control indication from the second wireless device based on the monitoring. The operations of 1510 may be performed in accordance with examples as disclosed herein. In some examples, aspects of the operations of 1510 may be performed by a control indication manager 925 as described with reference to FIG. 9.

At 1515, in some examples, the method may include adjusting a first beam parameter of the one or more parameters associated with the first beam configuration, where a beam width associated with the first beam configuration decreases based on receiving the control indication. The operations of 1515 may be performed in accordance with examples as disclosed herein. In some examples, aspects of the operations of 1515 may be performed by a beam parameter component 955 as described with reference to FIG. 9.

At 1520, in some examples, the method may include transmitting an indication of the first beam parameter to the second wireless device based on adjusting the first beam parameter, where communicating with the second wireless device is based on transmitting the indication. The operations of 1520 may be performed in accordance with examples as disclosed herein. In some examples, aspects of the operations of 1520 may be performed by a beam parameter component 955 as described with reference to FIG. 9.

At 1525, the method may include communicating with the second wireless device based on determining one or more parameters associated with the first beam configuration, the second beam configuration, or both in accordance with receiving the control indication. The operations of 1525 may be performed in accordance with examples as disclosed herein. In some examples, aspects of the operations of 1525 may be performed by a full-duplex communication component 940 as described with reference to FIG. 9.

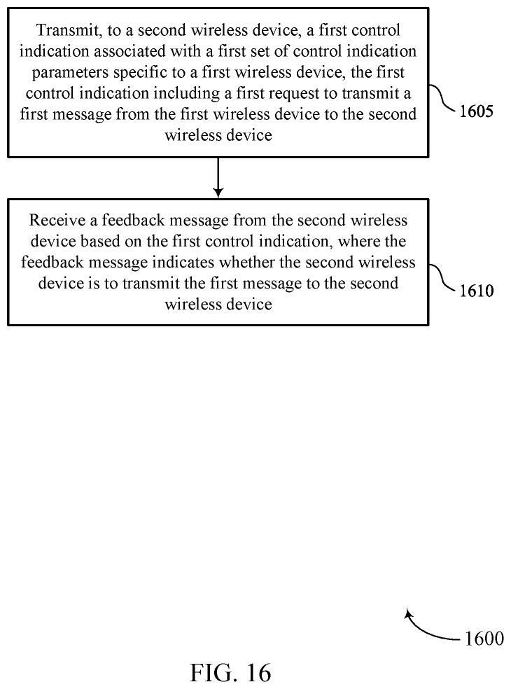

FIG. 16 shows a flowchart illustrating a method 1600 that supports full duplex collision handling and beam pairing in accordance with one or more aspects of the present disclosure. The operations of the method 1600 may be implemented by a wireless device or its components as described herein. For example, the operations of the method 1600 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1605, the method may include transmitting, to a second wireless device, a first control indication associated with a first set of control indication parameters specific to the first wireless device, the first control indication including a first request to transmit a first message from the first wireless device to the second wireless device. The operations of 1605 may be performed in accordance with examples as disclosed herein. In some examples, aspects of the operations of 1605 may be performed by a control indication manager 925 as described with reference to FIG. 9.

At 1610, the method may include receiving a feedback message from the second wireless device based on the first control indication, where the feedback message indicates whether the second wireless device is to transmit the first message to the second wireless device. The operations of 1610 may be performed in accordance with examples as disclosed herein. In some examples, aspects of the operations of 1610 may be performed by a feedback message component 930 as described with reference to FIG. 9.

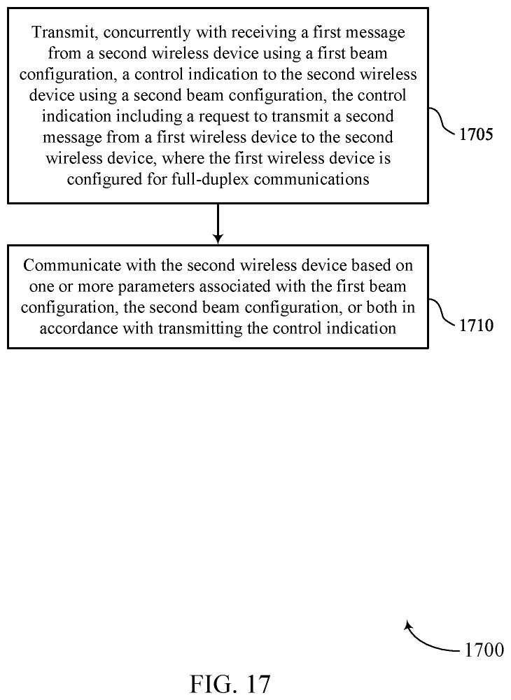

FIG. 17 shows a flowchart illustrating a method 1700 that supports full duplex collision handling and beam pairing in accordance with one or more aspects of the present disclosure. The operations of the method 1700 may be implemented by a wireless device or its components as described herein. For example, the operations of the method 1700 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1705, the method may include transmitting, concurrently with receiving a first message from a second wireless device using a first beam configuration, a control indication to the second wireless device using a second beam configuration, the control indication including a request to transmit a second message from the first wireless device to the second wireless device, where the first wireless device is configured for full-duplex communications. The operations of 1705 may be performed in accordance with examples as disclosed herein. In some examples, aspects of the operations of 1705 may be performed by a control indication manager 925 as described with reference to FIG. 9.

At 1710, the method may include communicating with the second wireless device based on one or more parameters associated with the first beam configuration, the second beam configuration, or both in accordance with transmitting the control indication. The operations of 1710 may be performed in accordance with examples as disclosed herein. In some examples, aspects of the operations of 1710 may be performed by a full-duplex communication component 940 as described with reference to FIG. 9.

The following provides an overview of aspects of the present disclosure:

Aspect 1: A method for wireless communications by a first wireless device, comprising: receiving, from a second wireless device, a first control indication associated with a first set of control indication parameters specific to the second wireless device, the first control indication comprising a first request to transmit a first message from the second wireless device to the first wireless device, wherein the first wireless device is configured for full-duplex communications; receiving, from a third wireless device, a second control indication associated with a second set of control indication parameters specific to the third wireless device, the second control indication comprising a second request to transmit a second message from the third wireless device to the first wireless device; and transmitting a feedback message to the second wireless device, the third wireless device, or both based at least in part on the first control indication and the second control indication, wherein the feedback message indicates whether the second wireless device, the third wireless device, or both are to transmit to the first wireless device.

Aspect 2: The method of aspect 1, wherein the first set of control indication parameters comprises one or more first signal types, one or more first sequence parameters, one or more first reference signal parameters, one or more first waveform parameters, one or more first frequency resources, or any combination thereof; and the second set of control indication parameters comprises one or more second signal types, one or more second sequence parameters, one or more second reference signal parameters, one or more second waveform parameters, one or more second frequency resources, or any combination thereof.

Aspect 3: The method of any of aspects 1 through 2, further comprising: differentiating the first control indication from the second control indication based at least in part on a difference of at least one parameter between the first set of control indication parameters and the second set of control indication parameters.

Aspect 4: The method of any of aspects 1 through 3, wherein transmitting the feedback message to the second wireless device comprises: transmitting the feedback message indicating that the second wireless device is to transmit the first message based at least in part on determining that the first request comprises an indication of an urgent message request.

Aspect 5: The method of any of aspects 1 through 4, wherein the first control indication and the second control indication are at least partially overlapped in a time domain, the method further comprising: receiving, via the first control indication, a first priority indication associated with the second wireless device; receiving, via the second control indication, a second priority indication associated with the third wireless device; and transmitting the feedback message indicating that the second wireless device is to transmit the first message based at least in part on the first priority indication being associated with a higher priority than the second priority indication.

Aspect 6: The method of any of aspects 1 through 5, wherein the first control indication is orthogonal to the second control indication in a frequency domain based at least in part on the first set of control indication parameters and the second set of control indication parameters.

Aspect 7: The method of any of aspects 1 through 6, wherein transmitting the feedback message comprises: transmitting an acknowledgment message to the second wireless device indicating that the second wireless device is to transmit the first message based at least in part on a first priority associated with the second wireless device being higher than a second priority associated with the third wireless device; and transmitting a not-acknowledgment message to the third wireless device indicating that the third wireless device is not to transmit the second message.

Aspect 8: The method of any of aspects 1 through 7, wherein transmitting the feedback message comprises: transmitting, to the second wireless device, a first indication of first time resources in which the second wireless device is allowed to transmit the first message; and transmitting, to the third wireless device, a second indication of second time resources in which the third wireless device is to transmit the second message, wherein the first time resources are before the second time resources in a time domain based at least in part on a first priority associated with the second wireless device being higher than a second priority associated with the third wireless device.

Aspect 9: The method of any of aspects 1 through 8, wherein transmitting the feedback message comprises: transmitting an acknowledgment message to the second wireless device indicating that the second wireless device is to transmit the first message based at least in part on a first priority associated with the second wireless device being higher than a second priority associated with the third wireless device; and transmitting, to the third wireless device, an indication of a time offset after which the third wireless device is to transmit the second message.

Aspect 10: The method of any of aspects 1 through 9, wherein the first wireless device has scheduled a transmission of a third message from a fourth wireless device to the first wireless device, the method further comprising: transmitting the feedback message to the second wireless device indicating that the second wireless device is not to transmit the first message based at least in part on a first priority associated with the fourth wireless device being higher than a second priority associated with the second wireless device; and transmitting a second feedback message to the third wireless device indicating that the third wireless device is not to transmit the second message based at least in part on the first priority associated with the fourth wireless device being higher than a third priority associated with the third wireless device.

Aspect 11: The method of any of aspects 1 through 9, wherein the first wireless device has scheduled a transmission of a third message from a fourth wireless device to the first wireless device, the method further comprising: transmitting a cancelation message to the fourth wireless device that cancels the transmission of the third message based at least in part on a first priority associated with the fourth wireless device being lower than a second priority associated with the second wireless device or a third priority associated with the third wireless device.

Aspect 12: The method of any of aspects 1 through 11, wherein further comprising: receiving the first control indication and the second control indication via a sidelink channel; and transmitting the feedback message via the sidelink channel.

Aspect 13: The method of any of aspects 1 through 12, wherein further comprising: transmitting a third message to a fourth wireless device, wherein the first control indication and the second control indication are received simultaneously with transmitting the third message.

Aspect 14: A method for wireless communications by a first wireless device, comprising: monitoring, concurrently with transmitting a first message to a second wireless device using a first beam configuration, for a control indication from the second wireless device using a second beam configuration, the control indication comprising a request to transmit a second message from the second wireless device to the first wireless device, wherein the first wireless device is configured for full-duplex communications; receiving the control indication from the second wireless device based at least in part on the monitoring; and communicating with the second wireless device based at least in part on determining one or more parameters associated with the first beam configuration, the second beam configuration, or both in accordance with receiving the control indication.

Aspect 15: The method of aspect 14, further comprising: adjusting a first beam parameter of the one or more parameters associated with the first beam configuration, wherein a beam width associated with the first beam configuration decreases based at least in part on receiving the control indication; and transmitting an indication of the first beam parameter to the second wireless device based at least in part on adjusting the first beam parameter, wherein communicating with the second wireless device is based at least in part on transmitting the indication.

Aspect 16: The method of aspect 15, further comprising: receiving the second message from the second wireless device based at least in part on transmitting the indication; and adjusting the first beam parameter of the one or more parameters associated with the first beam configuration, wherein the beam width associated with the first beam configuration increases based at least in part on receiving the second message.

Aspect 17: The method of any of aspects 14 through 16, further comprising: reducing a transmit power parameter of the one or more parameters associated with the first beam configuration, wherein a value of the transmit power parameter is based at least in part on a self-interference metric associated with the first beam configuration and the second beam configuration.

Aspect 18: The method of any of aspects 14 through 17, further comprising: transmitting an indication to the second wireless device to increase a transmit power parameter of the one or more parameters associated with the second beam configuration, wherein a value of the transmit power parameter is based at least in part on a self-interference metric associated with the first beam configuration and the second beam configuration.

Aspect 19: A method for wireless communications by a first wireless device, comprising: transmitting, to a second wireless device, a first control indication associated with a first set of control indication parameters specific to the first wireless device, the first control indication comprising a first request to transmit a first message from the first wireless device to the second wireless device; and receiving a feedback message from the second wireless device based at least in part on the first control indication, wherein the feedback message indicates whether the second wireless device is to transmit the first message to the second wireless device.

Aspect 20: The method of aspect 19, wherein the first set of control indication parameters comprises one or more first signal types, one or more first sequence parameters, one or more first reference signal parameters, one or more first waveform parameters, one or more first frequency resources, or any combination thereof.

Aspect 21: The method of any of aspects 19 through 20, wherein receiving the feedback message from the second wireless device comprises: receiving the feedback message indicating that the first wireless device is to transmit the first message based at least in part on the first request comprising an indication of an urgent message request.

Aspect 22: The method of any of aspects 19 through 21, further comprising: transmitting, via the first control indication, a first priority indication associated with the first wireless device; and receiving the feedback message indicating that the first wireless device is to transmit the first message based at least in part on the first priority indication.

Aspect 23: The method of any of aspects 19 through 22, wherein the first control indication is orthogonal to a second control indication from another wireless device in a frequency domain based at least in part on the first set of control indication parameters.

Aspect 24: The method of any of aspects 19 through 23, wherein receiving the feedback message comprises: receiving an acknowledgment message or a not-acknowledgment message from the second wireless device indicating whether the first wireless device is to transmit the first message based at least in part on a first priority associated with the first wireless device.

Aspect 25: The method of any of aspects 19 through 24, wherein receiving the feedback message comprises: receiving, from the second wireless device, a first indication of first time resources in which the first wireless device is allowed to transmit the first message, wherein the first time resources are based at least in part on a first priority associated with the first wireless device.

Aspect 26: The method of any of aspects 19 through 25, wherein receiving the feedback message comprises: receiving an indication of a time offset after which the first wireless device is to transmit the first message.

Aspect 27: The method of any of aspects 19 through 26, wherein further comprising: transmitting the first control indication via a sidelink channel; and receiving the feedback message via the sidelink channel.

Aspect 28: The method of any of aspects 19 through 27, wherein the first wireless device is configured for full-duplex communications.

Aspect 29: A method for wireless communications by a first wireless device, comprising: transmitting, concurrently with receiving a first message from a second wireless device using a first beam configuration, a control indication to the second wireless device using a second beam configuration, the control indication comprising a request to transmit a second message from the first wireless device to the second wireless device, wherein the first wireless device is configured for full-duplex communications; and communicating with the second wireless device based at least in part on one or more parameters associated with the first beam configuration, the second beam configuration, or both in accordance with transmitting the control indication.

Aspect 30: The method of aspect 29, further comprising: receiving an indication of a first beam parameter from the second wireless device based at least in part on transmitting the control indication, wherein a beam width associated with the first beam configuration decreases based at least in part on receiving the indication.

Aspect 31: The method of aspect 30, further comprising: transmitting the second message to the second wireless device based at least in part on receiving the indication, wherein the beam width associated with the first beam configuration increases based at least in part on transmitting the second message.

Aspect 32: The method of any of aspects 29 through 31, further comprising: receiving an indication from the second wireless device to increase a transmit power parameter of the one or more parameters associated with the second beam configuration, wherein a value of the transmit power parameter is based at least in part on a self-interference metric associated with the first beam configuration and the second beam configuration.

Aspect 33: A first wireless device for wireless communications, comprising one or more memories storing processor-executable code, and one or more processors coupled with the one or more memories and individually or collectively operable to execute the code to cause the first wireless device to perform a method of any of aspects 1 through 13.

Aspect 34: A first wireless device for wireless communications, comprising at least one means for performing a method of any of aspects 1 through 13.

Aspect 35: A non-transitory computer-readable medium storing code for wireless communications, the code comprising instructions executable by one or more processors to perform a method of any of aspects 1 through 13.

Aspect 36: A first wireless device for wireless communications, comprising one or more memories storing processor-executable code, and one or more processors coupled with the one or more memories and individually or collectively operable to execute the code to cause the first wireless device to perform a method of any of aspects 14 through 18.

Aspect 37: A first wireless device for wireless communications, comprising at least one means for performing a method of any of aspects 14 through 18.

Aspect 38: A non-transitory computer-readable medium storing code for wireless communications, the code comprising instructions executable by one or more processors to perform a method of any of aspects 14 through 18.

Aspect 39: A first wireless device for wireless communications, comprising one or more memories storing processor-executable code, and one or more processors coupled with the one or more memories and individually or collectively operable to execute the code to cause the first wireless device to perform a method of any of aspects 19 through 28.

Aspect 40: A first wireless device for wireless communications, comprising at least one means for performing a method of any of aspects 19 through 28.

Aspect 41: A non-transitory computer-readable medium storing code for wireless communications, the code comprising instructions executable by one or more processors to perform a method of any of aspects 19 through 28.

Aspect 42: A first wireless device for wireless communications, comprising one or more memories storing processor-executable code, and one or more processors coupled with the one or more memories and individually or collectively operable to execute the code to cause the first wireless device to perform a method of any of aspects 29 through 32.

Aspect 43: A first wireless device for wireless communications, comprising at least one means for performing a method of any of aspects 29 through 32.

Aspect 44: A non-transitory computer-readable medium storing code for wireless communications, the code comprising instructions executable by one or more processors to perform a method of any of aspects 29 through 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
receive, from a second wireless device, a first control indication associated with a first set of control indication parameters specific to the second wireless device, the first control indication comprising a first request to transmit a first message from the second wireless device to the first wireless device, wherein the first wireless device is configured for full-duplex communications;
receive, from a third wireless device, a second control indication associated with a second set of control indication parameters specific to the third wireless device, the second control indication comprising a second request to transmit a second message from the third wireless device to the first wireless device; and
transmit a feedback message to the second wireless device, the third wireless device, or both based at least in part on the first control indication and the second control indication, wherein the feedback message indicates whether the second wireless device, the third wireless device, or both are to transmit to the first wireless device.

2. The first wireless device of claim 1, wherein:
the first set of control indication parameters comprises one or more first signal types, one or more first sequence parameters, one or more first reference signal parameters, one or more first waveform parameters, one or more first frequency resources, or any combination thereof; and
the second set of control indication parameters comprises one or more second signal types, one or more second sequence parameters, one or more second reference signal parameters, one or more second waveform parameters, one or more second frequency resources, or any combination thereof.

3. The first wireless device of claim 1, wherein the one or more processors are individually or collectively further operable to execute the code to cause the first wireless device to:
differentiate the first control indication from the second control indication based at least in part on a difference of at least one parameter between the first set of control indication parameters and the second set of control indication parameters.

4. The first wireless device of claim 1, wherein, to transmit the feedback message to the second wireless device, the one or more processors are individually or collectively operable to execute the code to cause the first wireless device to:
transmit the feedback message indicating that the second wireless device is to transmit the first message based at least in part on determining that the first request comprises an indication of an urgent message request.

5. The first wireless device of claim 1, wherein the first control indication and the second control indication are at least partially overlapped in a time domain, and the one or more processors are individually or collectively further operable to execute the code to cause the first wireless device to:
receive, via the first control indication, a first priority indication associated with the second wireless device;
receive, via the second control indication, a second priority indication associated with the third wireless device; and
transmit the feedback message indicating that the second wireless device is to transmit the first message based at least in part on the first priority indication being associated with a higher priority than the second priority indication.

6. The first wireless device of claim 1, wherein the first control indication is orthogonal to the second control indication in a frequency domain based at least in part on the first set of control indication parameters and the second set of control indication parameters.

7. The first wireless device of claim 1, wherein, to transmit the feedback message, the one or more processors are individually or collectively operable to execute the code to cause the first wireless device to:
transmit an acknowledgment message to the second wireless device indicating that the second wireless device is to transmit the first message based at least in part on a first priority associated with the second wireless device being higher than a second priority associated with the third wireless device; and
transmit a not-acknowledgment message to the third wireless device indicating that the third wireless device is not to transmit the second message.

8. The first wireless device of claim 1, wherein, to transmit the feedback message, the one or more processors are individually or collectively operable to execute the code to cause the first wireless device to:
transmit, to the second wireless device, a first indication of first time resources in which the second wireless device is allowed to transmit the first message; and
transmit, to the third wireless device, a second indication of second time resources in which the third wireless device is to transmit the second message, wherein the first time resources are before the second time resources in a time domain based at least in part on a first priority associated with the second wireless device being higher than a second priority associated with the third wireless device.

9. The first wireless device of claim 1, wherein, to transmit the feedback message, the one or more processors are individually or collectively operable to execute the code to cause the first wireless device to:
transmit an acknowledgment message to the second wireless device indicating that the second wireless device is to transmit the first message based at least in part on a first priority associated with the second wireless device being higher than a second priority associated with the third wireless device; and
transmit, to the third wireless device, an indication of a time offset after which the third wireless device is to transmit the second message.

10. The first wireless device of claim 1, wherein the first wireless device has scheduled a transmission of a third message from a fourth wireless device to the first wireless device, and the one or more processors are individually or collectively further operable to execute the code to cause the first wireless device to:
transmit the feedback message to the second wireless device indicating that the second wireless device is not to transmit the first message based at least in part on a first priority associated with the fourth wireless device being higher than a second priority associated with the second wireless device; and
transmit a second feedback message to the third wireless device indicating that the third wireless device is not to transmit the second message based at least in part on the first priority associated with the fourth wireless device being higher than a third priority associated with the third wireless device.

11. The first wireless device of claim 1, wherein the first wireless device has scheduled a transmission of a third message from a fourth wireless device to the first wireless device, and the one or more processors are individually or collectively further operable to execute the code to cause the first wireless device to:
transmit a cancelation message to the fourth wireless device that cancels the transmission of the third message based at least in part on a first priority associated with the fourth wireless device being lower than a second priority associated with the second wireless device or a third priority associated with the third wireless device.

12. The first wireless device of claim 1, wherein the one or more processors are individually or collectively further operable to execute the code to cause the first wireless device to:
receive the first control indication and the second control indication via a sidelink channel; and
transmit the feedback message via the sidelink channel.

13. The first wireless device of claim 1, wherein the one or more processors are individually or collectively further operable to execute the code to cause the first wireless device to:
transmit a third message to a fourth wireless device, wherein the first control indication and the second control indication are received simultaneously with transmitting the third message.

14. A first wireless device, comprising:
one or more memories storing processor-executable code; and
one or more processors coupled with the one or more memories and individually or collectively operable to execute the code to cause the first wireless device to:
monitor, concurrently with transmitting a first message to a second wireless device using a first beam configuration, for a control indication from the second wireless device using a second beam configuration, the control indication comprising a request to transmit a second message from the second wireless device to the first wireless device, wherein the first wireless device is configured for full-duplex communications;
receive the control indication from the second wireless device based at least in part on the monitoring; and
communicate with the second wireless device based at least in part on determining one or more parameters associated with the first beam configuration, the second beam configuration, or both in accordance with receiving the control indication.

15. The first wireless device of claim 14, wherein the one or more processors are individually or collectively further operable to execute the code to cause the first wireless device to:
adjust a first beam parameter of the one or more parameters associated with the first beam configuration, wherein a beam width associated with the first beam configuration decreases based at least in part on receiving the control indication; and
transmit an indication of the first beam parameter to the second wireless device based at least in part on adjusting the first beam parameter, wherein communicating with the second wireless device is based at least in part on transmitting the indication.

16. The first wireless device of claim 15, wherein the one or more processors are individually or collectively further operable to execute the code to cause the first wireless device to:
receive the second message from the second wireless device based at least in part on transmitting the indication; and
adjust the first beam parameter of the one or more parameters associated with the first beam configuration, wherein the beam width associated with the first beam configuration increases based at least in part on receiving the second message.

17. The first wireless device of claim 14, wherein the one or more processors are individually or collectively further operable to execute the code to cause the first wireless device to:
reduce a transmit power parameter of the one or more parameters associated with the first beam configuration, wherein a value of the transmit power parameter is based at least in part on a self-interference metric associated with the first beam configuration and the second beam configuration.

18. The first wireless device of claim 14, wherein the one or more processors are individually or collectively further operable to execute the code to cause the first wireless device to:
transmit an indication to the second wireless device to increase a transmit power parameter of the one or more parameters associated with the second beam configuration, wherein a value of the transmit power parameter is based at least in part on a self-interference metric associated with the first beam configuration and the second beam configuration.

19. A first wireless device, comprising:
one or more memories storing processor-executable code; and
one or more processors coupled with the one or more memories and individually or collectively operable to execute the code to cause the first wireless device to:
transmit, to a second wireless device, a first control indication associated with a first set of control indication parameters specific to the first wireless device, the first control indication comprising a first request to transmit a first message from the first wireless device to the second wireless device; and
receive a feedback message from the second wireless device based at least in part on the first control indication, wherein the feedback message indicates whether the second wireless device is to transmit the first message to the second wireless device.

20. The first wireless device of claim 19, wherein the first set of control indication parameters comprises one or more first signal types, one or more first sequence parameters, one or more first reference signal parameters, one or more first waveform parameters, one or more first frequency resources, or any combination thereof.

21. The first wireless device of claim 19, wherein, to receive the feedback message from the second wireless device, the one or more processors are individually or collectively operable to execute the code to cause the first wireless device to:
receive the feedback message indicating that the first wireless device is to transmit the first message based at least in part on the first request comprising an indication of an urgent message request.

22. The first wireless device of claim 19, wherein the one or more processors are individually or collectively further operable to execute the code to cause the first wireless device to:
transmit, via the first control indication, a first priority indication associated with the first wireless device; and
receive the feedback message indicating that the first wireless device is to transmit the first message based at least in part on the first priority indication.

23. The first wireless device of claim 19, wherein the first control indication is orthogonal to a second control indication from another wireless device in a frequency domain based at least in part on the first set of control indication parameters.

24. The first wireless device of claim 19, wherein, to receive the feedback message, the one or more processors are individually or collectively operable to execute the code to cause the first wireless device to:
receive an acknowledgment message or a not-acknowledgment message from the second wireless device indicating whether the first wireless device is to transmit the first message based at least in part on a first priority associated with the first wireless device.

25. The first wireless device of claim 19, wherein, to receive the feedback message, the one or more processors are individually or collectively operable to execute the code to cause the first wireless device to:
receive, from the second wireless device, a first indication of first time resources in which the first wireless device is allowed to transmit the first message, wherein the first time resources are based at least in part on a first priority associated with the first wireless device.

26. The first wireless device of claim 19, wherein, to receive the feedback message, the one or more processors are individually or collectively operable to execute the code to cause the first wireless device to:
receive an indication of a time offset after which the first wireless device is to transmit the first message.

27. The first wireless device of claim 19, wherein the one or more processors are individually or collectively further operable to execute the code to cause the first wireless device to:
transmit the first control indication via a sidelink channel; and
receive the feedback message via the sidelink channel.

28. A first wireless device, comprising:
one or more memories storing processor-executable code; and
one or more processors coupled with the one or more memories and individually or collectively operable to execute the code to cause the first wireless device to:
transmit, concurrently with receiving a first message from a second wireless device using a first beam configuration, a control indication to the second wireless device using a second beam configuration, the control indication comprising a request to transmit a second message from the first wireless device to the second wireless device, wherein the first wireless device is configured for full-duplex communications; and
communicate with the second wireless device based at least in part on one or more parameters associated with the first beam configuration, the second beam configuration, or both in accordance with transmitting the control indication.

29. The first wireless device of claim 28, wherein the one or more processors are individually or collectively further operable to execute the code to cause the first wireless device to:
receive an indication of a first beam parameter from the second wireless device based at least in part on transmitting the control indication, wherein a beam width associated with the first beam configuration decreases based at least in part on receiving the indication.

30. The first wireless device of claim 29, wherein the one or more processors are individually or collectively further operable to execute the code to cause the first wireless device to:
transmit the second message to the second wireless device based at least in part on receiving the indication, wherein the beam width associated with the first beam configuration increases based at least in part on transmitting the second message.
